(19) United States
(12) Patent Application Publication
(10) Pub. No.: US 2009/0123720 A1
(43) Pub. Date: May 14, 2009

(54) SOLUTION PROCESSED ORGANOMETALLIC COMPLEXES AND THEIR USE IN ELECTROLUMINESCENT DEVICES

(76) Inventors: Zhikuan Chen, Singapore (SG); Chun Huang, Singapore (SG); Changgua Zhen, Singapore (SG); Junhong Yao, Singapore (SG)

Correspondence Address: KLARQUIST SPARKMAN, LLP, 121 SW SALMON STREET, SUITE 1600, PORTLAND, OR, 97204, US

(21) Appl. No.: 11/817,147

(22) PCT Filed: Mar. 1, 2005
(86) PCT No.: PCT/SG05/00065

§ 371 Date: Aug. 24, 2007

(51) Int. Cl. C09K 11/06; C07F 15/00; H01J 1/63

(52) U.S. Cl. 428/220; 546/4; 252/301.16; 428/690

(57) ABSTRACT

The invention provides phosphorescent organometallic complexes. The complexes of the invention may be prepared as films further comprising a charge carrying host material may be used at an emissive layer in organic light emitting devices. In one embodiment, the complex is a hyper-branched organoiridium complex comprising a 2-phenylpuridine ligand wherein the phenyl ring or the pyridine ring contains 4 non-hydrogen substituents. In another embodiment, the complex is an organoiridium complex comprising a substituted 2-phenyl pyridine ligand, wherein at least one substituent contains a spiro group.

### FIELD OF THE INVENTION

The invention relates to phosphorescent organometallic complexes and to electroluminescent devices comprising such organometallic complexes.

### BACKGROUND OF THE INVENTION

Organic light emitting devices (OLEDs) contain at least one organic layer that may luminescence when voltage is applied across the layer. Certain OLEDS have sufficient luminescence, color properties and lifetimes to be considered as viable alternatives to conventional inorganic-based liquid crystal display (LCD) panels. Relative to traditional LCD panels, OLEDs are generally lighter, consume less energy and may be made on flexible substrates, properties that are obviously beneficial to many battery operated handheld devices. Since being first commercially introduced in a car stereo in 1998, OLEDs are now beginning to appear in a range of commercial products including cell-phones, electric shavers, PDAs, digital cameras and the like.

Initial attention in developing OLEDs focussed on fluorescent emission. Upon the recombination of injected holes and electrons in electroluminescent devices, approximately only one quarter of the generated excitons are in the singlet state and capable of fluorescent emission. The remaining three quarters of excitons are fin the triplet state, and are generally precluded from relaxing by radiative mechanisms in organic molecules near room temperature. As a result, the energy contained in approximately 75% of excitons generated in an electrofluorescent device is lost and the excited triplet states return to the ground state through non-radiative pathways, which may undesirably increase the operating temperature of the device.

Recent work has demonstrated that higher quantum efficiency devices can be made from phosphorescent emitters, in which both singlet and triplet excitons can be used for light emission (Baldo et al. 1998, Nature 395:151). Spin-orbit coupling between a heavy metal and an organic ligand may mix excited singlet and triplet states, allowing for rapid intersystem crossing and the luminescent decay of the excited triplet state by phosphorescence (Baldo et al. 1998, Nature 395:154). As a consequence, electroluminescent OLEDs based on phosphorescent materials have a theoretical internal quantum efficiency approaching 100%.

Phosphorescence is a much slower process than fluorescence, and as a result, excited states may decay through pathways that are not relevant to fluorescent emission. A pronounced characteristic of electrophosphorescence is a “roll-off” in efficiency at higher current densities (Baldo et al 2000, Phys. Rev. B. 62(16):10967). This roll-off has largely been attributed to triplet-triplet annihilation (T-T annihilation), and, to a lesser extent, to the saturation of the emission states (Adachi et al, 2000, J. Appl. Phys. 87(11):8049). The saturation of emissive sites may be alleviated to some extent by increasing the concentration of the acceptor/guest in the emissive layer, however, high concentrations of acceptor/guest will generally lead to increased bimolecular quenching of the triplet excitons.

Since the discovery that phosphorescent materials could be used for OLED device applications (Baldo et al. 1998, Nature 395:151) great effort has been devoted to develop new electroluminescent materials with higher efficiency and tunable emission color as well as seeking new materials which could be fabricated into devices through solution processing. Specific interest has focused on iridium (III) based complexes, such as, fac-tris(phenylpyridine)iridium (“Ir(ppy)₃”), bis(2-phenyl pyridinato-N,C2′)iridium (acetylacetonate) (“(ppy)₂Ir(acac)”) and their derivatives.

One approach to reducing T-T annihilation and concentration self-quenching has been to use acceptors with shorter excited triplet lifetimes (Chen et al. 2002, Appl. Phys. Lett. 80(13):2308; Baldo et al. 2000, Phys. Rev. B. 62(16):10967). For this reason, iridium complexes are generally preferred over platinum porphyrins which have about an order of magnitude greater lifetime (Chen et al. 2002, Appl. Phys. Lett 80(13):2308).

Thompson et al. have disclosed blue phosphorescent emitters based on iridium complexes (US 2002/0182441A1; WO02/15645A1). High efficiency green and red emitters based on (Ir(ppy)₃) and bis(2-(2′-benzo[4,5-a]thienylpyridinato-N,C³)iridium(acetylacetone) [Btp₂Ir(acac)] have been also been developed (Adachi et al. 2001, Appl. Phys. Lett. 78:1622; Lamansky et al. 2001, J. Am. Chem. Soc. 123: 4304).

Recently, progress has been made to develop solution processable phosphorescent materials, wherein the phosphorescent guest is dispersed in a host polymer or small molecule matrix that may be capable of forming uniform thin films through solution processing techniques such as spin coating or inkjet printing (Gong et al. 2002, J. Adv. Mater. 14: 581; Zhu et al. 2002, Appl. Phys. Lett. 80: 2045; Gong et al. 2002, J. Appl. Phys. Lett. 81:3711; Gong et al. 2003, Adv. Mater. 15: 45; Chen et al. 2003, Appl. Phys. Lett. 82: 1006). Higher guest concentrations may result in phase separation, which may negatively affect the quantum efficiency and lifetime of the device (Chen et al 2002, J. Am. Chem. Soc. 125:636; Lee at al. 2002, Optical Materials 21:119; WO 03/079736).

Phosphorescent emitting complexes grafted onto a polymer chain as side chains have also been developed (Lee et al. 2002, Optical Materials 21:119)). The excitons generated by the polymers can be transferred to the phosphorescent emitting centers and efficient green, red and white light emission have been demonstrated (Chen et al. 2003, J. Am. Chem. Soc. 125:636). In these polymers, electron transfer is primarily intermolecular (Lee at al. 2002, Optical Materials 21:119).

The incorporation of dendritic structures into phosphorescent complexes may facilitate solution processability and prevent concentration dependent self-quenching of the complexes as well as T-T annihilation. TOT annihilation will become even more serious when the devices are operated at high current densities for high luminance, where the population of triplet excited states may begin to saturate (Baldo et al 1999, Pure Appl. Chem. 71(11):2095). Higher generation dendritic ligands may more effectively separate metal complexes from each other, thereby suppressing the bimolecular interactions that may cause self-quenching and triplet-triplet annihilation (Markham et al. 2002, Appl. Phys. Lett. 80(15):2645). The suppression of these non-radiative decay pathways would allow for higher device efficiencies.

Phosphorescent organometallic dendrimers may be processed into high quality thin films through spin coating with host materials. For example, WO 02/066552 discloses dendrimers having metal ions as pall of the core. When the metal chromophore is at the core of the dendrimer, it will be relatively isolated from core chromophores of adjacent molecules, which is proposed to minimize concentration quenching and/or T-T annihilation.

WO 03/079736 discloses a light emitting device comprising a solution processable layer that contains Ir(ppy)₃-based dendrimers, wherein at least one dendron has a nitrogen heteroaryl group or a nitrogen atom directly bound to at least two aromatic groups.

WO 2004/020448 discloses a number of Ir(ppy)₃-based dendrimers designed to overcome intermolecular phosphor interactions that reduce quantum efficiency and it is proposed that the dendritic architecture keeps the cores separated and reduces triplet-triplet quenching.

US 2004/0137263 discloses a number of first and second generation Ir(Ppy)₃ dendrimers wherein at least one dendrite is fully conjugated. The surface groups of the dendrites can be modified such that the dendrimers are soluble in suitable solvents. Alternatively, the dendrites may be selected to change the electrical properties of the phosphorescent guest.

Markham et al. (2002, Appl. Phys. Lett. 80(15): 2645) disclose the photoluminescence quantum yields (PLQY) of first and second generation Ir(ppy)₃ dendrimers. The increased PLQY of second generation dendrons was attributed to the greater separation of the Ir(ppy)₃ cores, thus reducing concentration-dependent bimolecular quenching effects. Unlike Ir(ppy)₃ doped in an electron transporting host material, good quality films may be prepared by spin coating a solution of the dendrimers in the same electron-transporting host material.

Other non-dendritic bulky ligands may have the same effect on the device performance. Xie et al. (Adv. Mat 2001, 13:1245) disclose (Ir(mppy)₃), a pinene derivative of Ir(Ppy)₃. Electroluminescent devices comprising Ir(mppy)₃ have a less pronounced roll-off in quantum efficiency than devices containing Ir(ppy)₃, which is attributed, in part, to the decreased lifetime of the excited Ir(mppy)₃ triplet state and the reduction in saturation of the guest/dopant. The external quantum efficiency of devices comprising Ir(mppy)₃ increases with increasing Ir(mppy)₃ concentration, even at high (e.g. 26 wt %) doping levels. The reduced self quenching of the Ir(mppy)₃ phosphor at higher concentrations was attributed to the sterically hindered pinene spacer in Ir(mppy)₃ that was thought to minimize bimolecular phosphor interactions.

Although the dendrimer approach can provide solution processable phosphorescent materials for efficient OLED devices, the synthesis and purification of the ligands and the resulting metal complexes is very tedious, especially when higher generations of dendrons are used.

Organometallic complexes based on Ir, Pt, Re, Rh and Zn with mono, bi- or tri-dentate coordinating ligands may be used as emitters for light emitting devices and may have much higher quantum efficiency relative to fluorescent emitting materials due to their ability to make use of both singlet and triplet excitons generated in the emitting layer. However, so far, most of the OLED devices based on organometallic complexes can only be prepared through vacuum deposition. While vacuum deposition is an attractive method to deposit small molecules and may additionally further purify the deposited organic molecules, the methods is generally expensive because of the high cost facilities required.

Solution processing is a lower cost technique and is more suitable for mass and fast production. It may also be better suited to prepare larger films that are required for large displays.

The present invention seeks to solve the above-mentioned problems and to provide high-efficiency phosphorescent light emitting materials that have decreased T-T annihilation. These materials may be readily prepared and may be fabricated into uniform thin films with either polymer or small molecule host materials through solution processing.

### SUMMARY OF THE INVENTION

In one aspect, the invention provides an organometallic compound of formula (I):

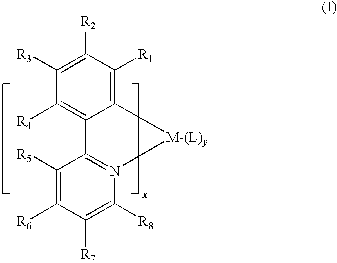

wherein

M is a d-block metal having a coordination number z, wherein z=6 or 4;

R₁ to R₈ are independently H, halo, optionally substituted alkyl, optionally substituted alkenyl, optionally substituted alkynyl, optionally substituted heteroalkyl, optionally substituted heteroalkenyl, optionally substituted heteroalkynyl, optionally substituted aryl, optionally substituted heteroaryl, amino, amido, carboxy, formyl, sulfo, sulfino, thioamido, hydroxy, halo or cyano, and two or more of R₁ to R₈ may form a ring together with the carbon atoms to which they are attached, provided that
if any one of R₁ to R₄ is H, none of R₅ to R₈ is H, or
if any one of R₅ to R₈ is H, none of R₁ to R₄ is H, or
at least one of R₁ to R₈ comprises a spiro group;

x is 1 to z/2;

L is a neutral or anionic ligand;

y is (z−2x)/2;

and R₂ is not fluorine.

In another aspect, the invention provides an organometallic compound of formula (I):

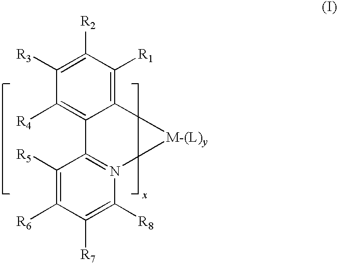

wherein:

M is a d-block metal having a coordination number z, wherein z=6 or 4;

R₁ and R₃ to R₈ are independently H, halo, optionally substituted alkyl, optionally substituted alkenyl, optionally substituted alkynyl, optionally substituted heteroalkyl, optionally substituted heteroalkenyl, optionally substituted heteroalkyl, optionally substituted aryl, optionally substituted heteroaryl, amino, amido, carboxy, formyl, sulfo, sulfino, thioamido, hydroxy, halo, or cyano, and two or more of R₁ to R₈ may form a ring together with the carbon atoms to which they are attached,

R₂ is independently H, optionally substituted alkyl, optionally substituted alkenyl, optionally substituted alkynyl, optionally substituted heteroalkyl, optionally substituted heteroalkenyl, optionally substituted heteroalkynyl, optionally substituted aryl, optionally substituted heteroaryl, amino, amido, carboxy, formyl, sulfo, sulfino, thioamido, hydroxy, or cyano, and two or more of R₁ to R₈ may form a ring together with the carbon atoms to which they are attached,
if any one of R₁ to R₄ is H, none of R₅ to R₈ is H, or
if any one of R₅ to R₈ is H, none of R₁ to R₄ is H, or
at least one of R₁ to R₈ comprises a spiro group;

x is 1 to z/2;

L is a neutral or anionic ligand; and

y is (z−2x)/2.

In another aspect, the invention provides films containing organometallic complexes according to various embodiments of the invention.

In yet another aspect, the invention provides electroluminescent devices comprising organometallic compounds according to various embodiments of the invention.

Other aspects and features of the present invention will become apparent to one of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention:

FIG. 1 shows a schematic representation of a single layer and multilayer electroluminescent device.

FIG. 2 shows the I-V-L curves of the device of ITO/PEDOT:PSS/PVK:PBD:B₂Ir(acac) (70 nm)/BCP (12 nm)/Alq₃ (20 nm)/Mg:Ag.

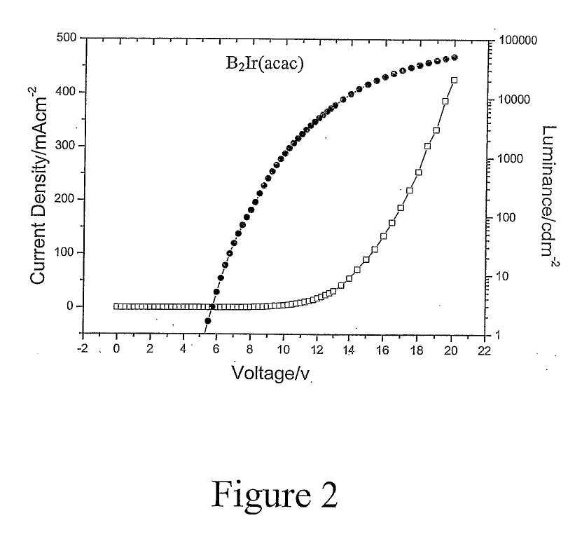

FIG. 3 shows the dependence of current efficiency on the current density of a ITO/PEDOT:PSS/PVK:PBD:B₂Ir(acac) (70 nm)/BCP (12 nm)/Alq₃ (20 nm)/Mg:Ag device.

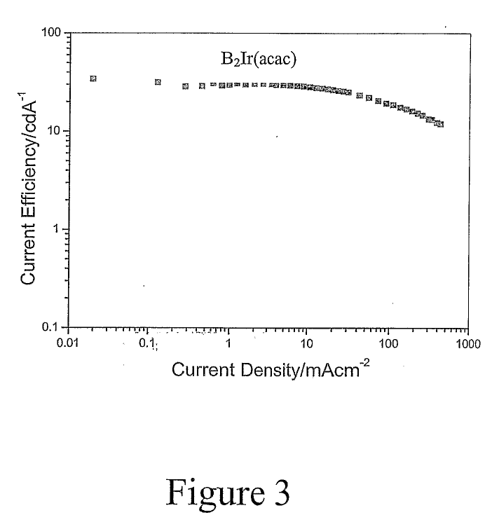

FIG. 4 shows the dependence of external quantum efficiency on the current density of a ITO/PEDOT:PSS/PVK:PBD:B₂Ir(acac) (70 nm)/BCP (12 nm)/Alq₃ (20 nm)/Mg:Ag device.

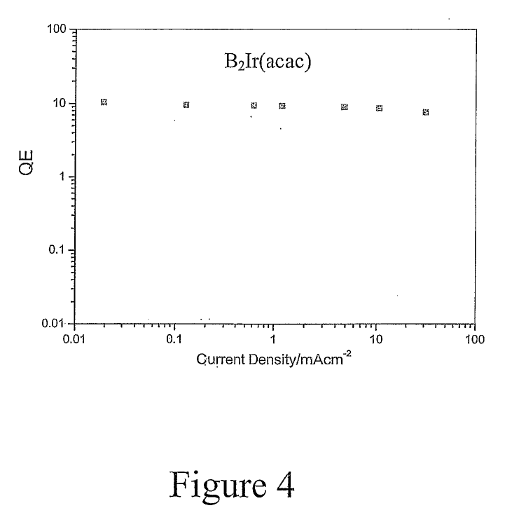

FIG. 5 shows the EL spectrum of the device of a ITO/PEDOT:PSS/PVK:PBD:B₂Ir(acac) (70 nm)/BCP (12 nm)/Alq₃ (20 nm)/Mg:Ag device.

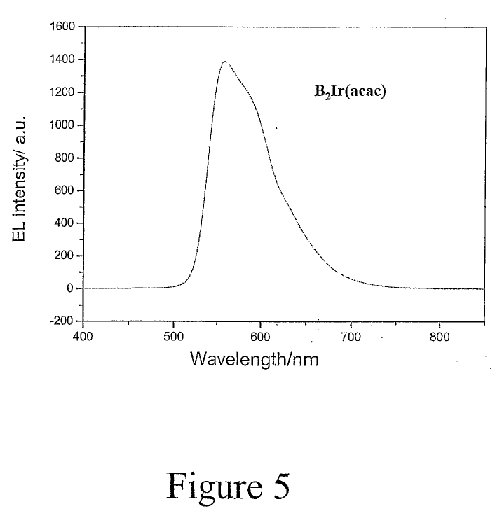

FIG. 6 shows the I-V-L plots of a ITO/PEDOT:PSS/PVK:PBD:E₂Ir(acac) (70 nm)/BCP (12 nm)/Alq₃ (20 nm)/Mg:Ag device.

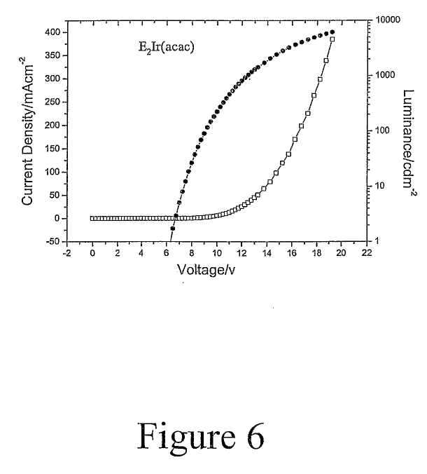

FIG. 7 shows the dependence of current efficiency on the current density of the device of a ITO/PEDOT:PSS/PVK:PBD:E₂Ir(acac) (70 nm)/BCP (12 nm)/Alq₃ (20 nm)/Mg:Ag device.

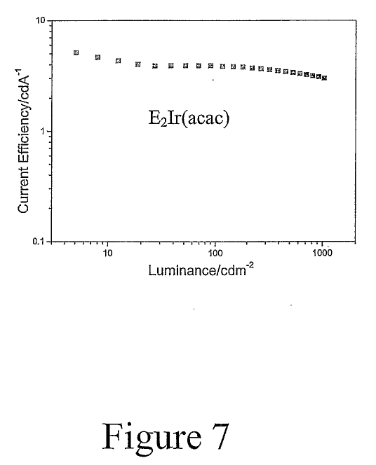

FIG. 8 shows the dependence of external quantum efficiency on the current density of a ITO/PEDOT:PSS/PVK:PBD:E₂Ir(acac) (70 nm)/BCP (12 nm)/Alq₃ (20 nm)/Mg:Ag device.

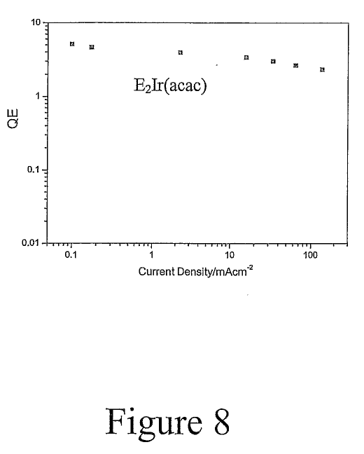

FIG. 9 shows the EL spectrum of a ITO/PEDOT:PSS/PVK:PBD:E₂Ir(acac) (70 nm)/BCP (12 nm)/Alq₃ (20 nm)/Mg:Ag device.

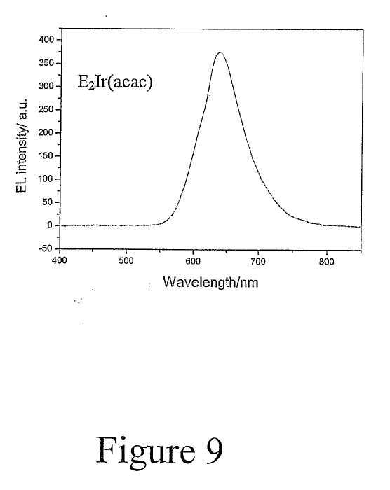

FIG. 10 shows the I-V-L plots of a ITO/PEDOT:PSS/PVK:PBD:G₂Ir(acac) (70 nm)/BCP (12 nm)/Alq₃ (20 nm)/Mg:Ag device.

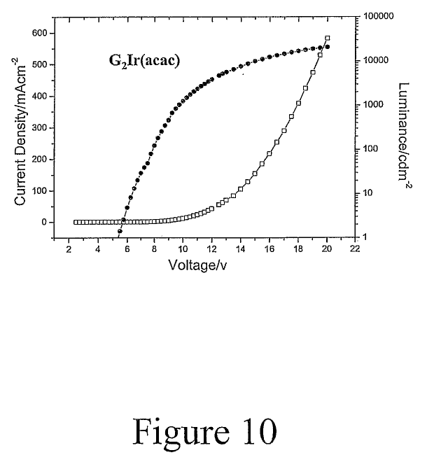

FIG. 11 shows the EL spectrum of a ITO/PEDOT:PSS/PVK:PBD:G₂Ir(acac) (70 nm)/BCP (12 nm)/Alq₃ (20 nm)/Mg:Ag device.

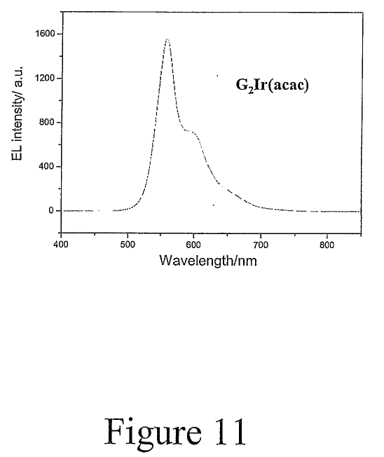

FIG. 12 shows a synthetic scheme for B₂Ir(acac).

FIG. 13 shows a synthetic scheme for G₂Ir(acac).

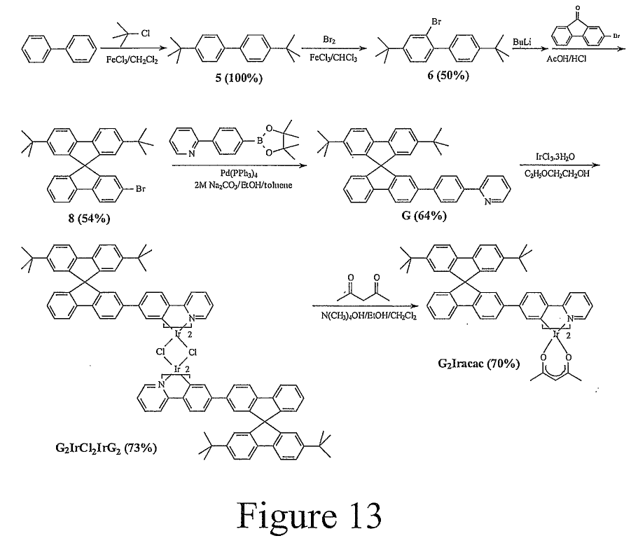

FIG. 14 shows the current efficiencies of devices comprising A₂Ir(acac), B₂Ir(acac), C₂Ir(acac), D₂Ir(acac), E₂Ir(acac), F₂Ir(acac), G₂Ir(acac) as a function of current density.

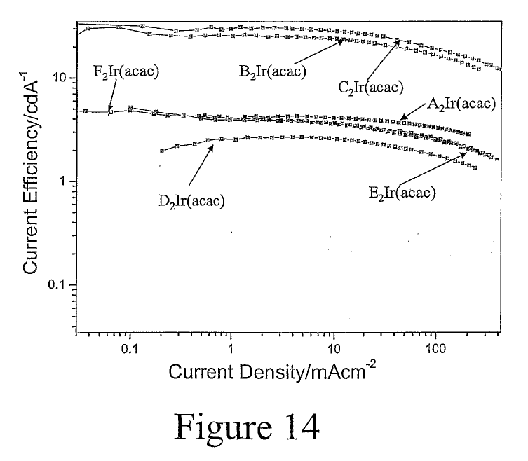

FIG. 15 shows the electroluminescence spectra of devices comprising C₂Ir(acac), F₂Ir(acac) and G₂Ir(acac).

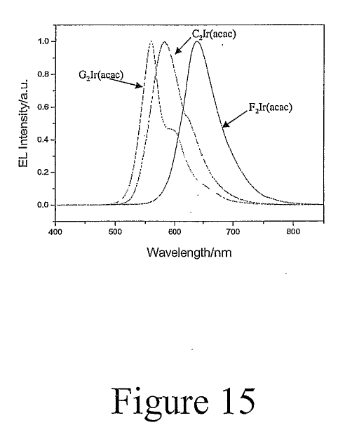

FIG. 16 shows the absorbance spectra of A₂Ir(acac), B₂Ir(acac), C₂Ir(acac), D₂Ir(acac), E₂Ir(acac) and F₂Ir(acac).

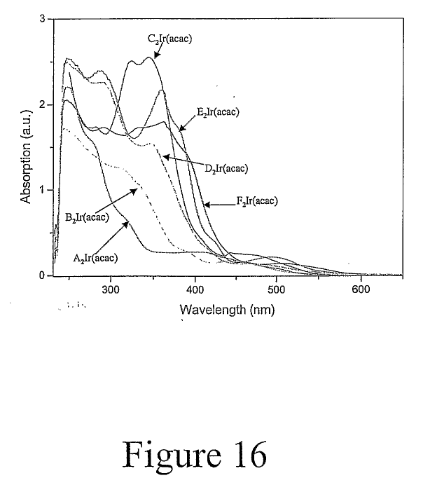

FIG. 17 shows the photoluminescence spectra of A₂Ir(acac), B₂Ir(acac), C₂Ir(acac), D₂Ir(acac), E₂Ir(acac) and F₂Ir(acac).

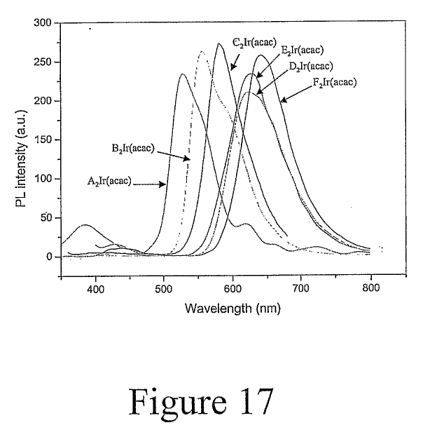

FIG. 18 shows cyclic voltammetry traces of A₂Ir(acac), B₂Ir(acac), C₂Ir(acac), D₂Ir(acac), E₂Ir(acac) and F₂Ir(acac) (FIG. 18 A) and the derived electronic parameter of the complexes (FIG. 18B).

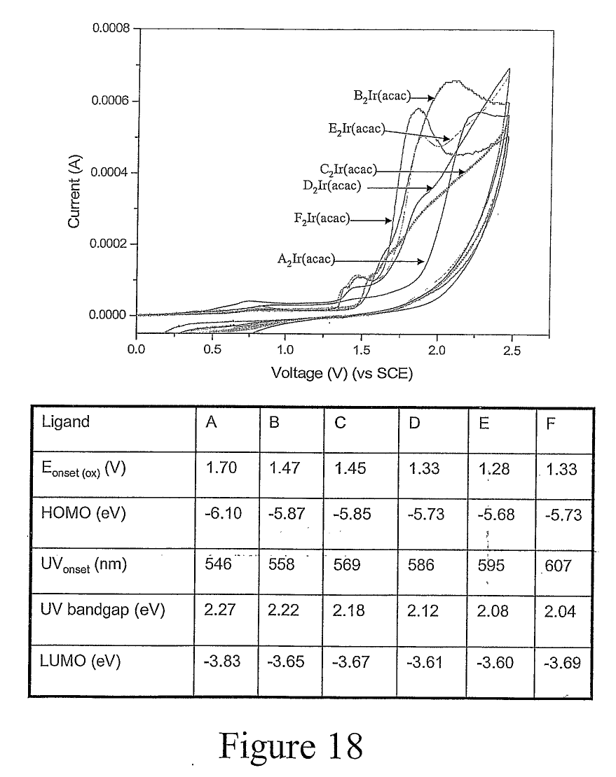

### DETAILED DESCRIPTION

There is disclosed an organometallic compound of formula (I):

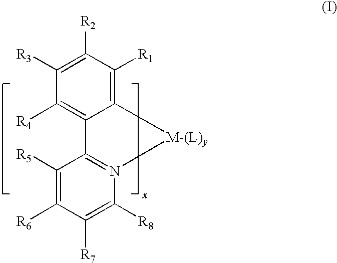

wherein

M is a d-block metal having a coordination number z, wherein z=6 or 4;

R₁ to R₈ are independently H, halo, optionally substituted alkyl, optionally substituted alkenyl, optionally substituted alkynyl, optionally substituted heteroalkyl, optionally substituted heteroalkenyl, optionally substituted heteroalkynyl optionally substituted aryl, optionally substituted heteroaryl, amino, amido, carboxy, formyl, sulfo, sulfino, thioamido, hydroxy, halo or cyano, and two or more of R₁ to R₈ may form a ring together with the carbon atoms to which they are attached, provided that
if any one of R₁ to R₄ is H, none of R₅ to R₈ is H, or
if any one of R₅ to R₈ is H, none of R₁ to R₄ is H, or
at least one of R₁ to R₈ comprises a spiro group;

x is 1 to z/2;

L is a neutral or anionic ligand;

and y is (z−2x)/2.

The aforementioned radical groups are defined according to their ordinary accepted meanings, as would be known to a person skilled in the art, as modified, where appropriate, by the following definitions.

As used herein, alkyl and heteroalkyl radicals have 1 to about 30 carbons, if linear, and about 3 to about 60 if branched or cyclic. Alkenyl, alkynyl, heteroalkenyl and heteroalkynyl radicals have 2 to about 30 carbon atoms if linear and about 3 to about 60 carbon atoms if branched or cyclic. Aryl and heteroaryl radicals have about 3 to about 60 carbon atoms.

As used herein, “alkyl” refers to a straight branched or cyclic saturated hydrocarbyl chain radical. The terms “alkenyl” and “alkynl” refer to non-saturated straight or branched, cyclic or non-cyclic hydrocarbyl chain radicals having at least one carbon-carbon double bond, and one carbon-carbon triple bond, respectively.

The terms “heteroalkyl”, heteroalkenyl” and “heteroalkynyl” refers to “alkyl”, “alkenyl” and “alkynyl” radicals in which at least one carbon atom has been replaced by a heteroatom, such as, for example, N, O, S, P or Si, including radicals wherein the heteroatom replaces the connecting carbon. For example, in the context of Formula I and where the heteroatom is oxygen, “heteroalkyl” would include radicals having an internal ether (—R—O—R) group and alkoxy radicals (—O—R) where the oxygen is connected to one of the carbon atoms of the 2-phenylpyridine ring.

As used herein, “aryl” refers to a class of monocyclyl and polycyclyl groups derived from an arene by the abstraction of a hydrogen atom from a carbon atom, and includes, but is not limited to, phenyl, naphthyl, biphenyl, fluorenyl, anthracenyl, phenanthracenyl, pyrenyl, indenyl, azulenyl, and acenaphthylenyl. As used herein, “aryl” also includes radicals wherein the aryl group is linked through a heteroatom, and would include, for example, “aryloxy”, “arylthio” and “arylamino” groups. As used herein, “arylamino” includes diarylamino and triarylamino groups.

As used herein, the term “heteroaryl” refers to the class of heterocyclyl groups derived from heteroarenes by the abstraction of a hydrogen atom. The heteroatoms of the heterocyclyl group may independently be O, S, N, Si or P. The heterocyclic groups may be monocyclyl or polycyclyl. “Heteroaryl” includes, but is not limited to, pyridinyl, pyrryl, furanyl, thiophenyl, indolyl, benzofuranyl, quinolyl, carbazolyl, silolyl and phospholyl. “Heteroaryl” also includes radicals wherein the heteroaryl group is linked through a heteroatom, such as, for example, “heteroaryloxy”, “heteroarylthio” and “heteroarylamino”. Heteroarylamino includes diheteroarylamino and triheteroarylamino groups.

Each of above mentioned radicals (“alkyl, “alkenyl”, “alkynyl”, “heteroalkyl”, heteroalkenyl”, heteroalkynyl”, “aryl” and “heteroaryl”) may optionally be substituted. As used herein, a “substituted radical” refers to one of the above mentioned radicals comprising one or more substituent, such as, for example, alkyl, alkenyl, alkynyl, heteroalkyl, heteroalkenyl, heteroalkynyl, aryl, heteroaryl, amino, amido, carbonyl, sulfonyl, thioamido, halo, hydroxy, oxy, silyl or siloxy. “Halo” or “halogen” refers to Cl, Br, F or I. Some of the above substituents (excluding halo, and hydroxy) may also themselves be substituted.

As used herein, “d-block metal” refers to an element in groups 3 to 12 of the periodic table, and includes, but is not limited to, Ir, Pt, Re, Rh, Os, Au and Zn.

As used herein, “spiro” refers to a group of compounds consisting in part of two rings having only one atom in common, such as, for example, spirobifluorene. The spiro atom may be, for example, carbon or silicon.

As used herein, “bandgap” refers to the energy difference between the highest occupied molecular orbital (HOMO) and the lowest unoccupied molecular orbital (LUMO).

As used herein, “ring” may be monocyclic or polycyclic. “Ring” includes fused systems wherein two atoms are common to two adjoining rings.

In different embodiments, the substituted 2-phenylpyridine group of formula I may be:

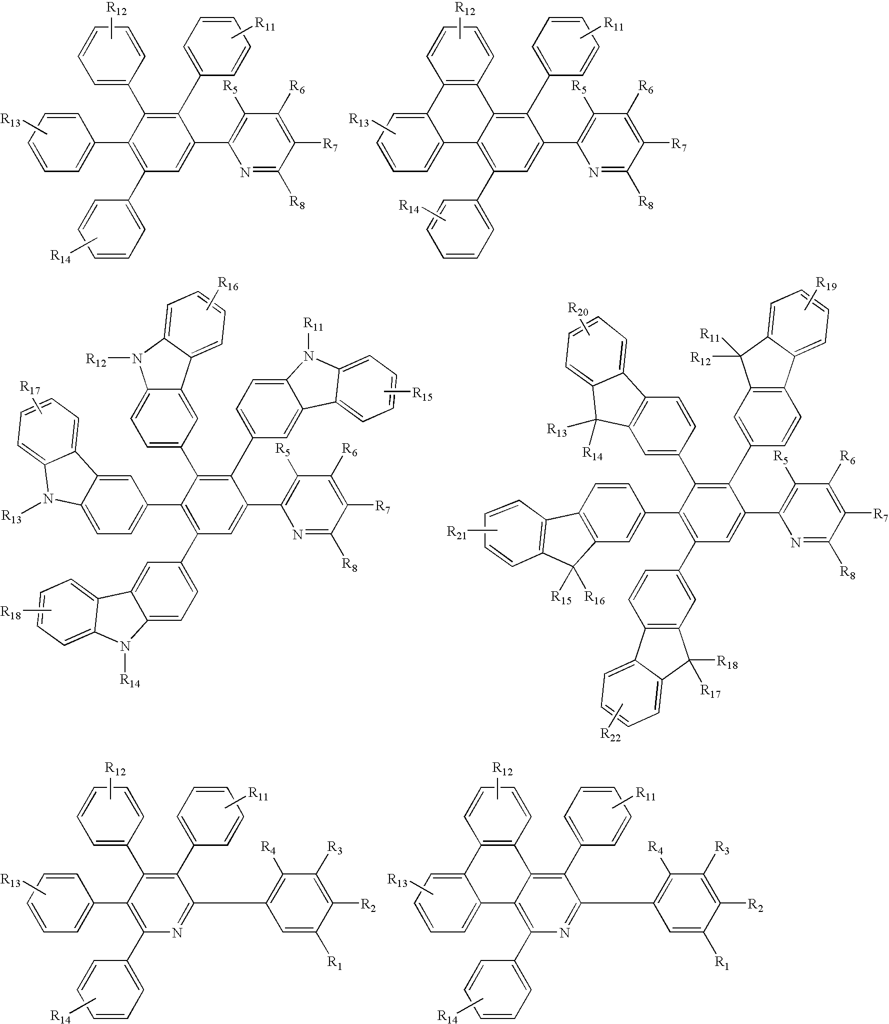

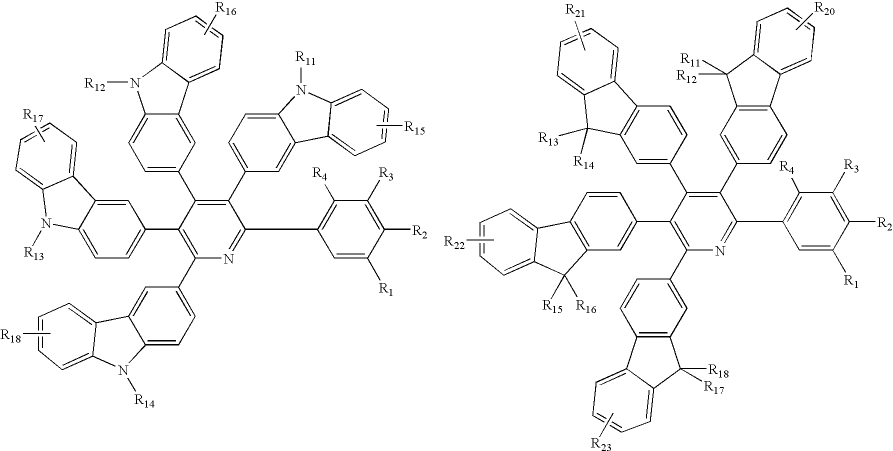

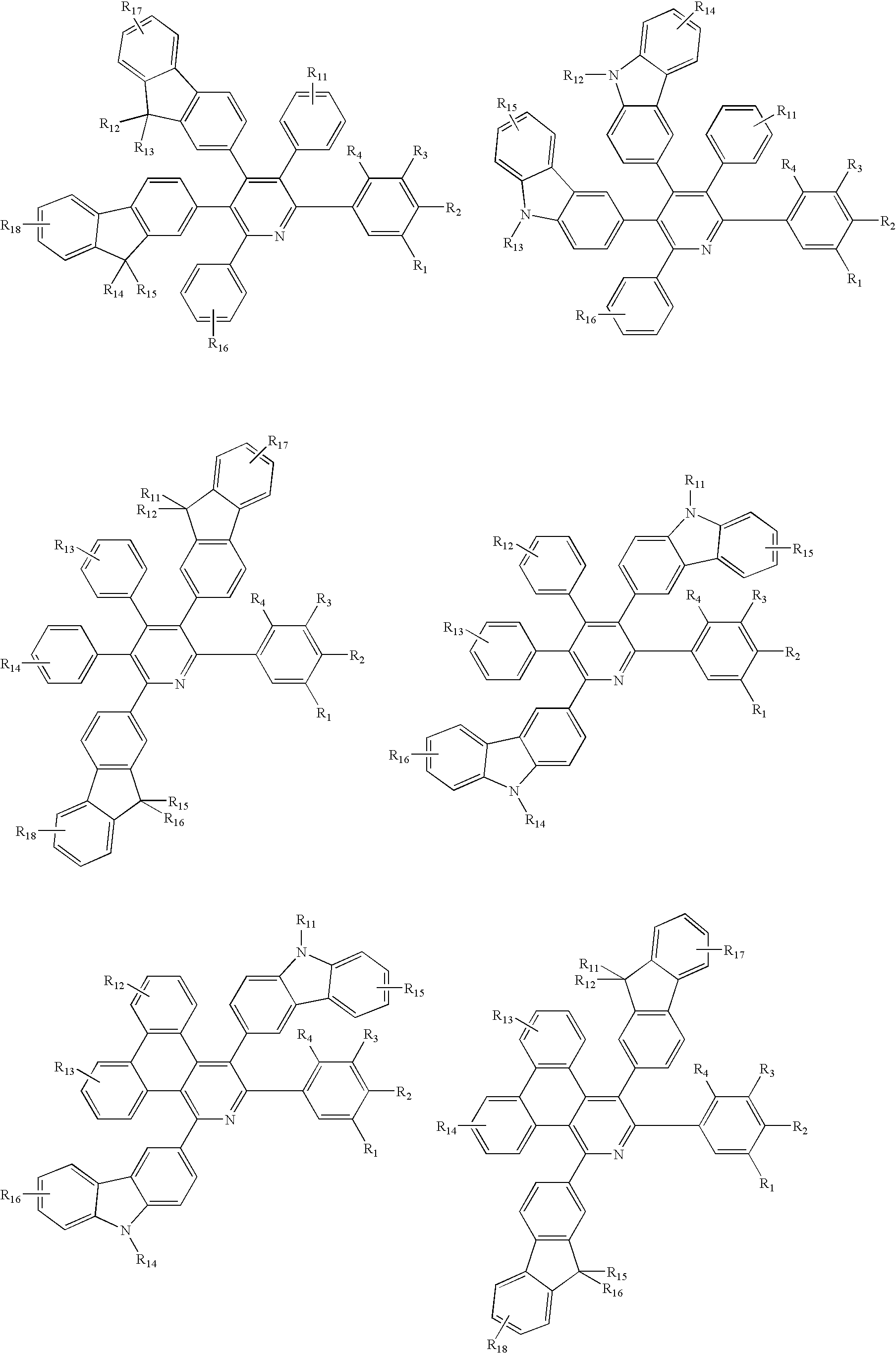

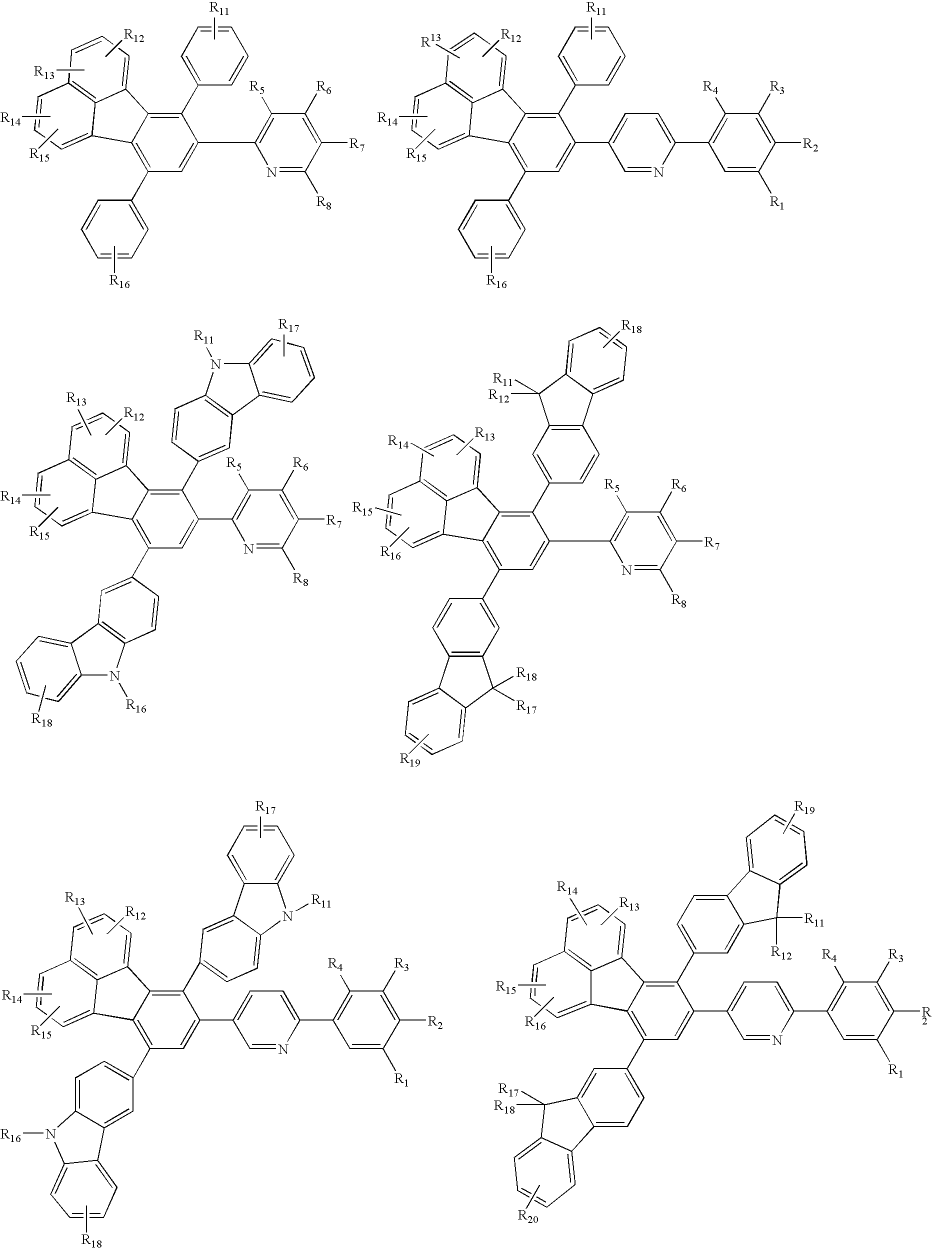

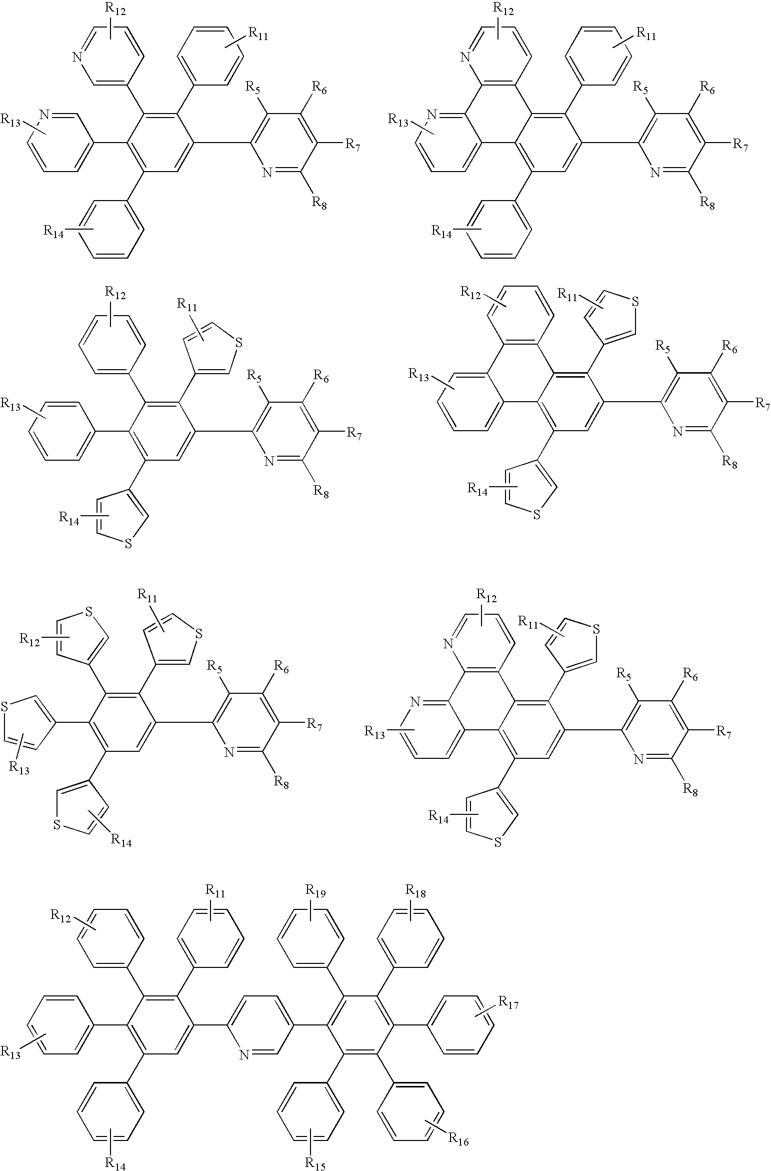

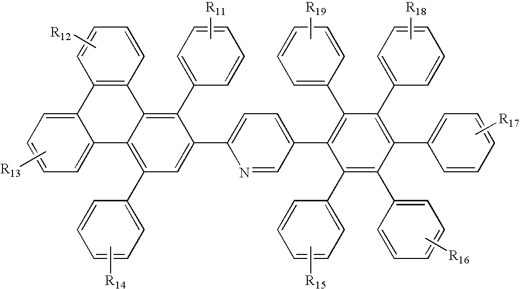

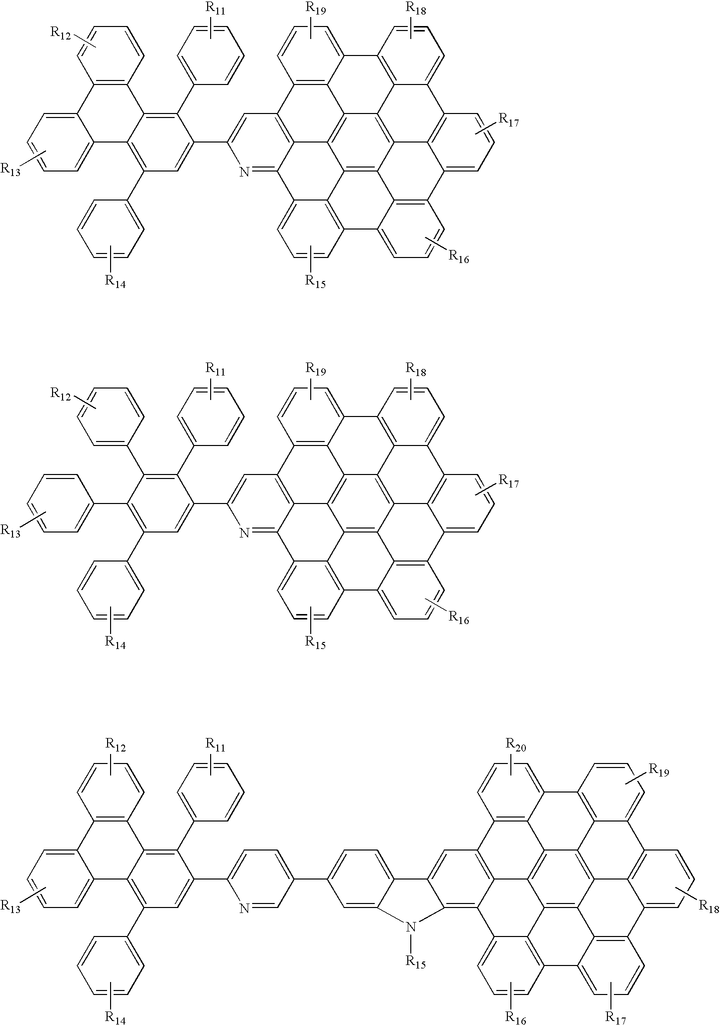

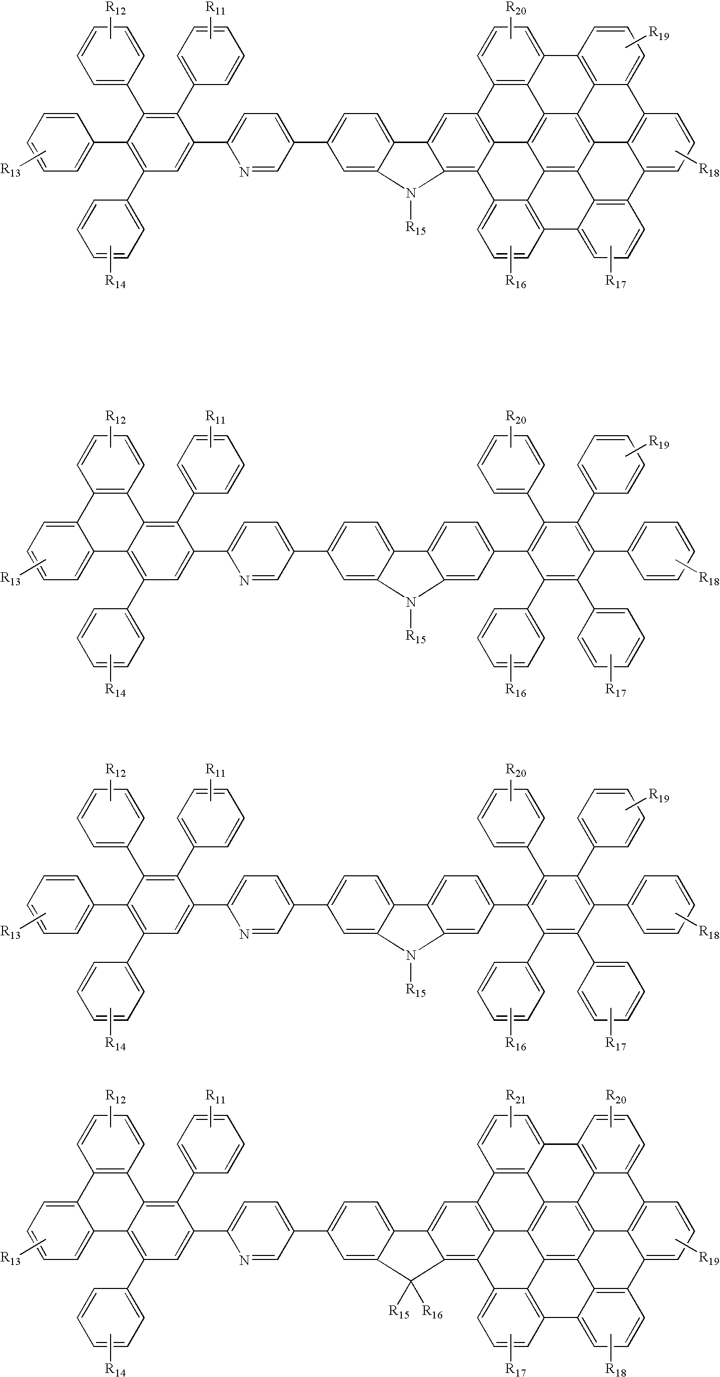

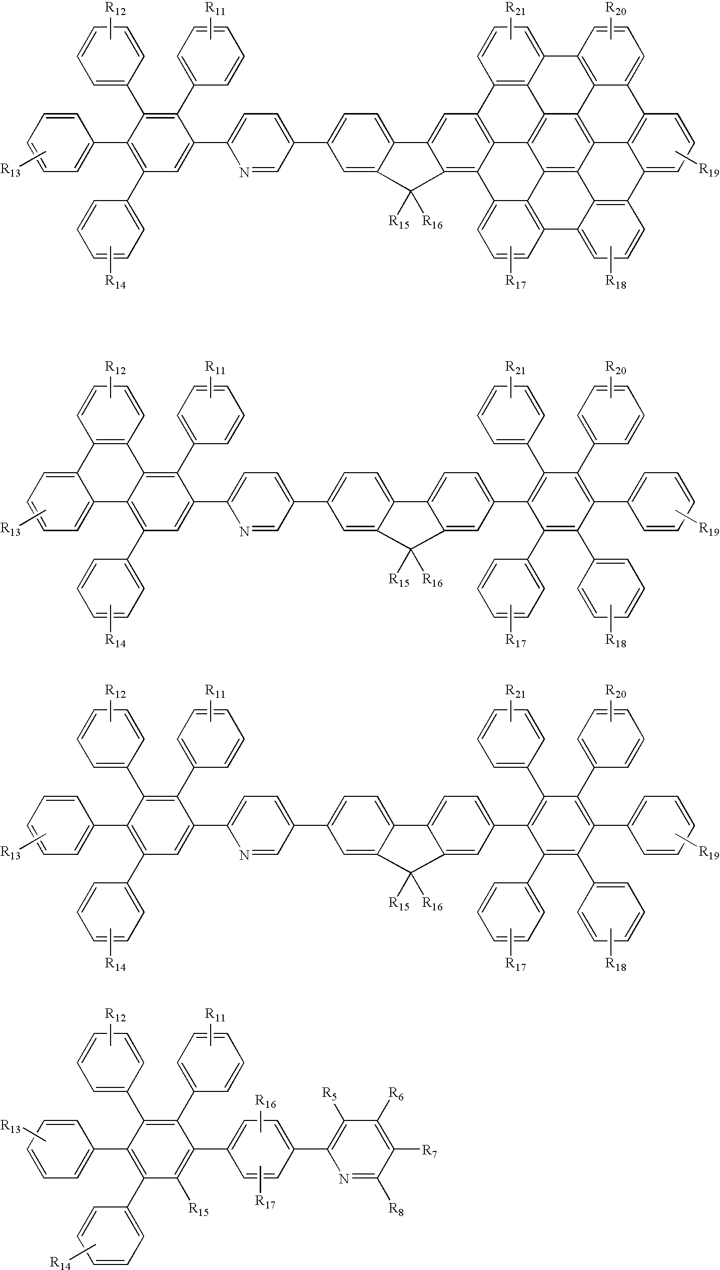

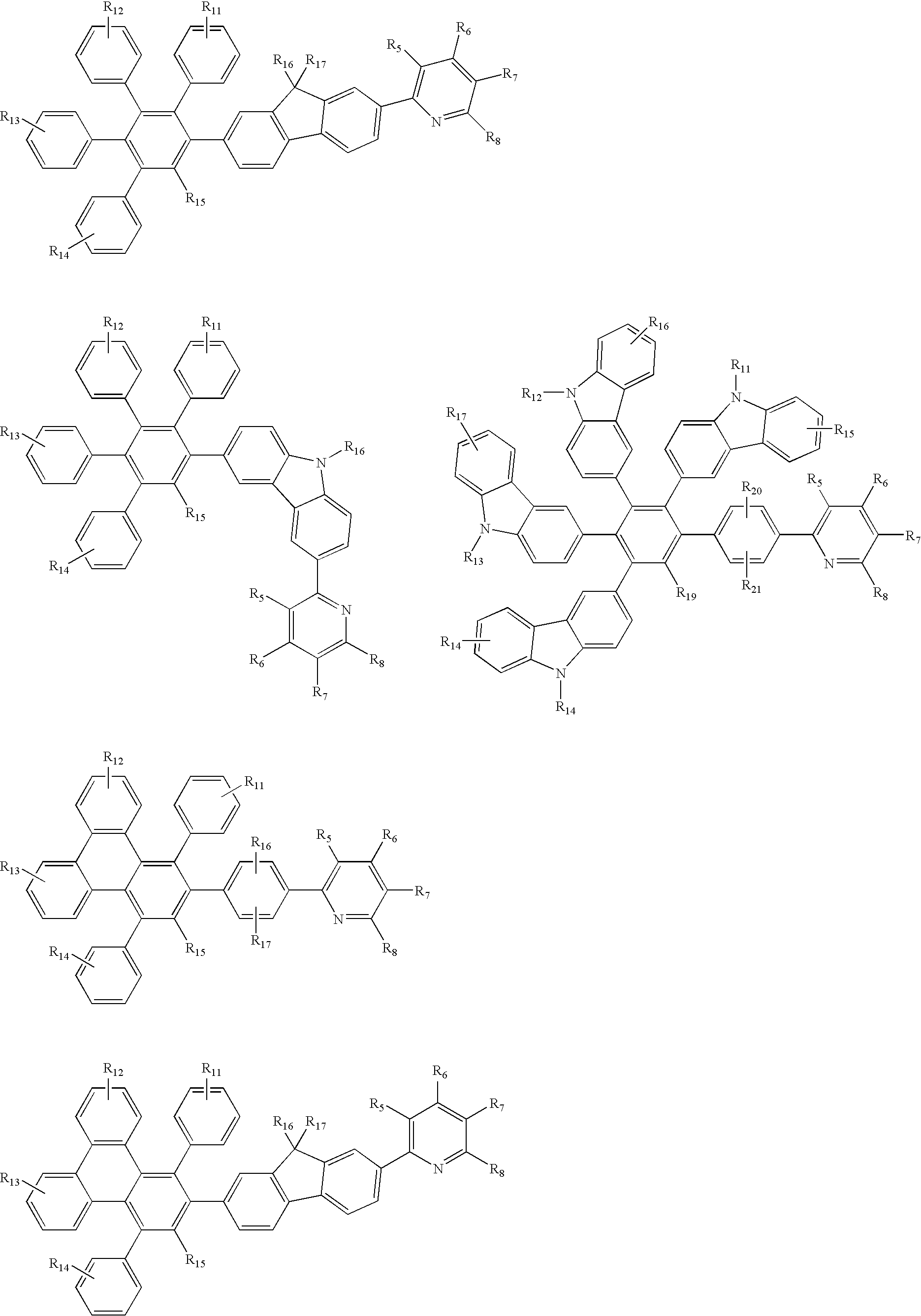

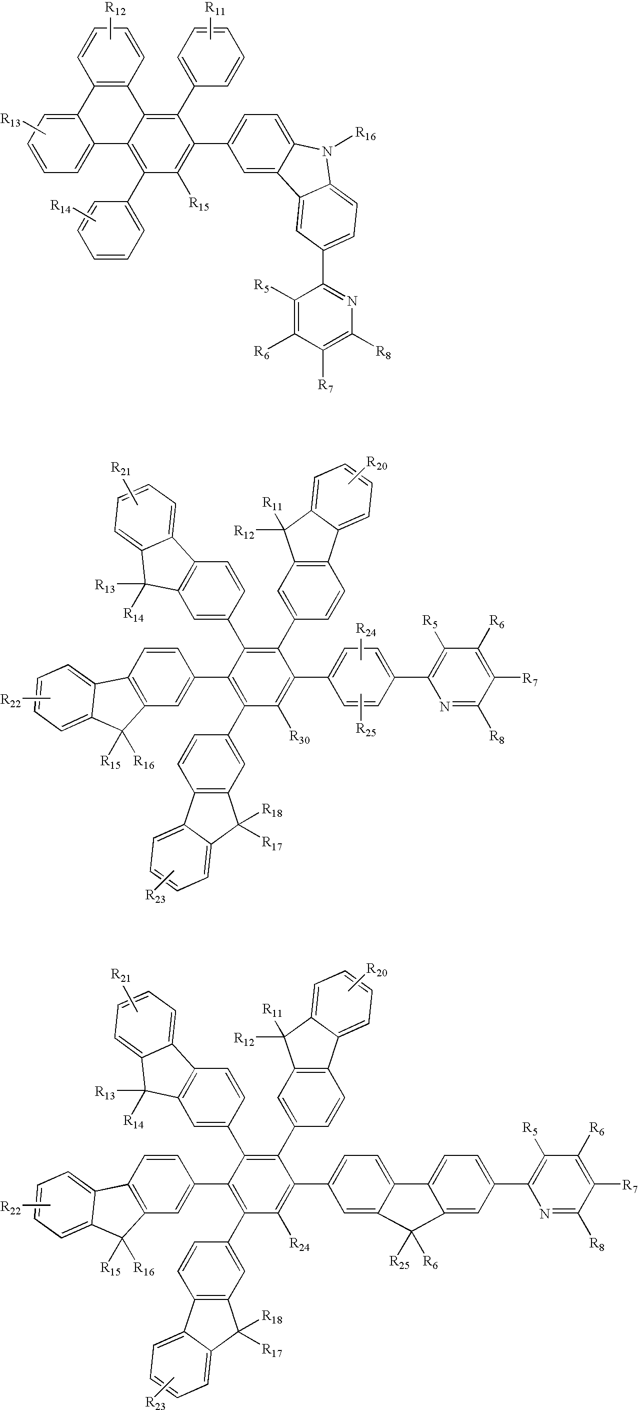

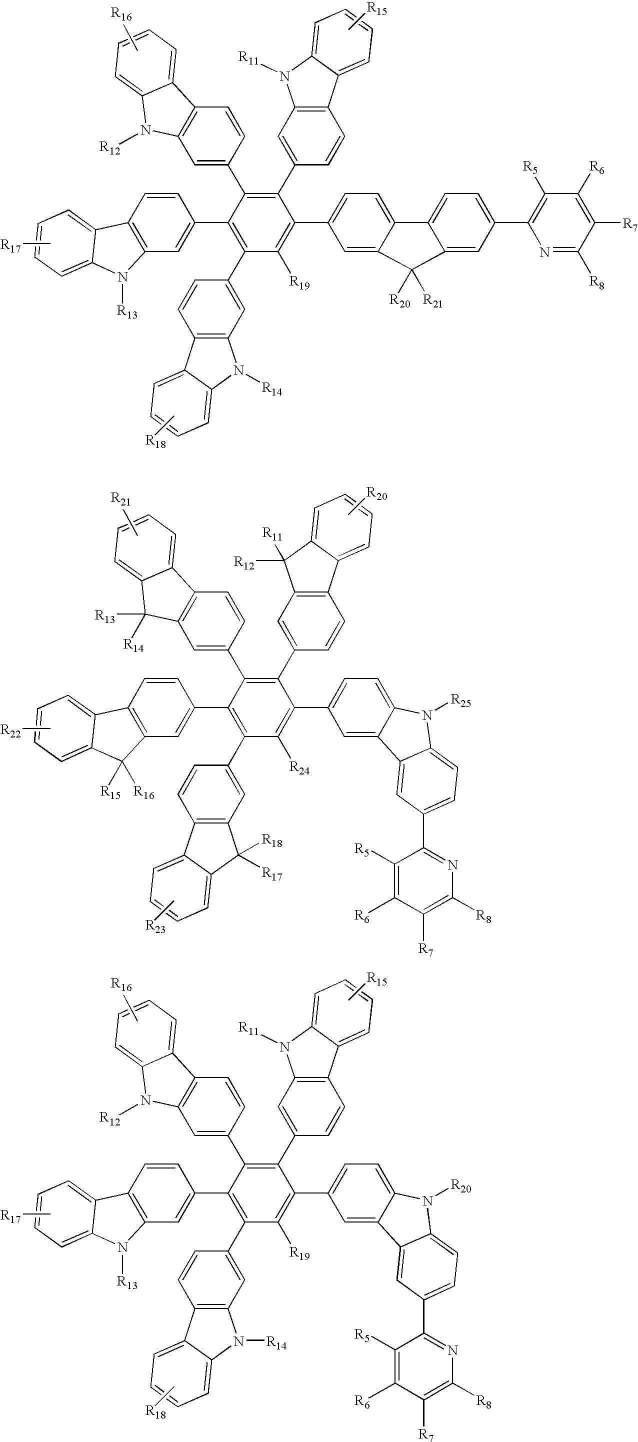

wherein R₁₁ to R₂₆ are independently defined as R₁, above. As would be understood by a person skilled in the art, bonds depicting any R group extending into an aryl or heteroaryl ring indicates that the R group may be at any available position of the aryl or heteroaryl ring. For example, the structures

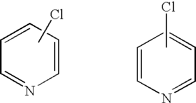

would be understood include, 2/6-chloropyridine, 3/5-chloropyridine and 4-chloropyridine.

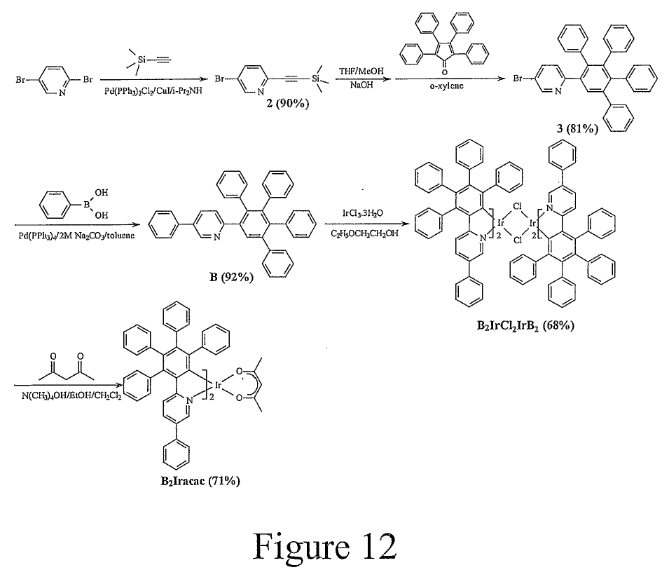

The branched substituted 2-phenylpyridine groups hereinafter also “branched ligands”) may be prepared through a Diels-Alder reaction in mild conditions. The yields may be as high as 80 to 90%. For example, a reaction scheme for the preparation of 2-(2′,3′,4′,5′-tetraphenyl)-5-phenyl-phenylpyridine (B) is shown in FIG. 12. Briefly, 2,5-dibromopyridine is added to (trimethylsilyl)acetylene in diisopropylamine with Pd(PPh₃)₂Cl₂ to create 2-trimethylsilyl-5-bromopyridine (2). Compound 2 was reacted with o-xylene in THF/Methanol/NaOH to generate of 2-(2′,3′,4′,5′-tetraphenyl)-phenyl-5-bromo-pyridine (3). Compound 3 was then reacted with phenylboronic acid in tetrakis(triphenylphosphine)palladium(0) in a solution of sodium carbonate/toluene to generate B. Alternatively, the branched ligands may be prepared by transition-metal-catalyzed [2+2+2]cyclotrimerization (S. Saito and Y. Yamamoto, Chem. Rev. 2000, 100: 2901-2915; M. Lautens, W. Klute, and W. Tam, Chem. Rev. 1996, 96: 49-92.]

Iridium complexes (M=Ir in formula I) of the branched ligands of the invention may be prepared by methods known in the art (see, for example, WO 2004/084326 and references therein). For example, the branched ligands can be reacted with iridium chloride hydrate to form a chloro-bridged dimer in high yields. The chloro-bridged dimer can then be further reacted with one or more additional ligands (L), which may be the same or different, to yield the final novel phosphorescent complexes of the present invention (see WO 02/15645; US 2002/034656). The disclosed branched ligands may also be reacted with a chloro-bridged L dimer, such as for example, L₂Ir(Cl)₂IrL₂ to form a new phosphorescent material of the invention.

L in formula I may be monodentate, bidentate or tridentate. Accordingly, the person skilled in the art would appreciate that the M-L bond depicted in formula I is not limited to a single M-L bond, but may include one, two or three bonds between M and L. L in formula I may be selected to tune the luminescent properties of the organometallic complex. For example, the 2-carboxypyridyl group in Bis(3,5-Difluoro-2-(2-pyridyl)phenyl-(2-carboxypyridyl) iridium (III) (“FIr(pic)”), blue-shifts the emission, spectra relative to the Bis(3,5-Difluoro-2-(2-pyridyl)phenyl-(acetylacetonate) iridium (III) complex. Suitable bidentate L groups would be known to a person skilled in the art and include, but are not limited to, hexafluoroacetonate, salicylidene, 8-hydroxyquinolate, and

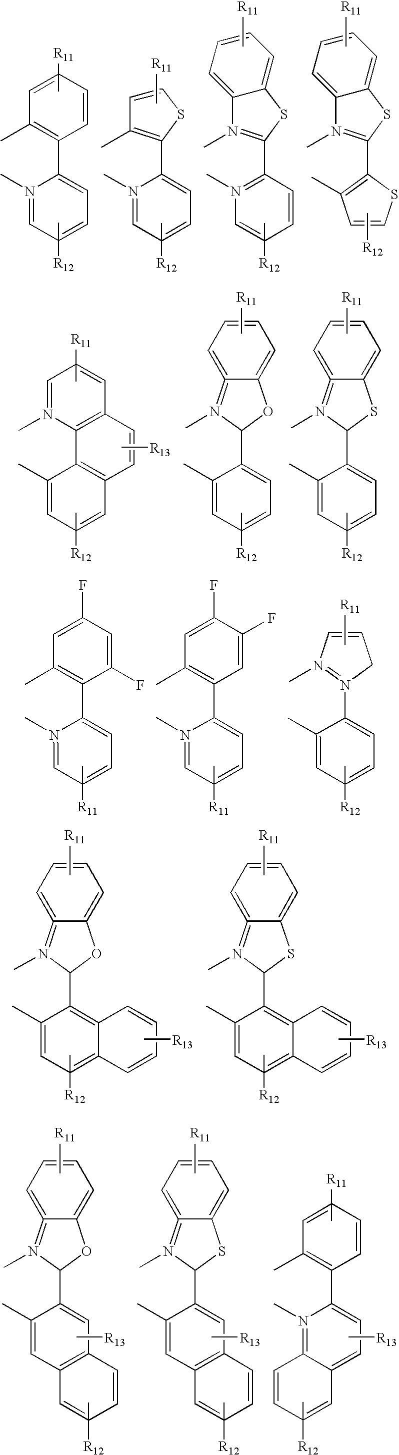

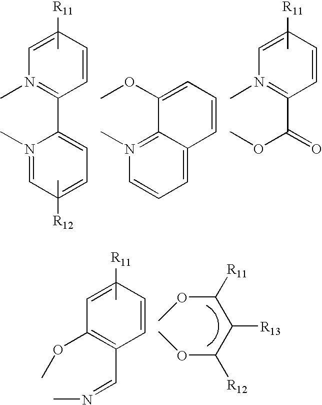

where R₁₁ to R₁₃ are independently defined as R₁ above and the two bonds to the d-block metal of the organometallic complex are shown for reference only. In specific embodiments, L is acetylacetone (“acac”).

Suitable mono-dentate L groups would also be known to a person skilled in the art and include, but are not limited to:

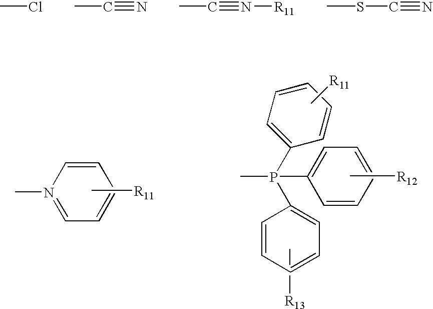

wherein R₁₁ to R₁₃ are independently defined as R₁, above and the bond to the metal atom is shown for reference only.

Suitable tri-dentate L groups would also be known to a person skilled in the art and include, but are not limited to:

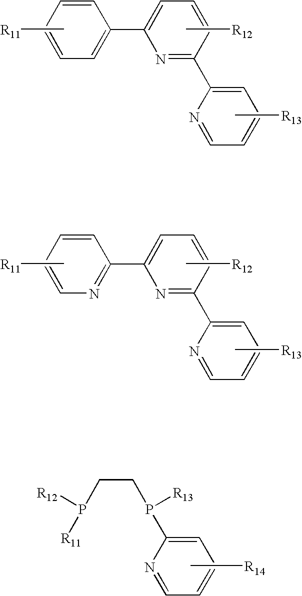

wherein R₁₁ to R₁₄ are independently defined as R₁, above, and the bonds to the metal atom are not depicted.

A person skilled in the art would appreciate that complexes of other metals, such as, for example, Rh, Pd or Pt may be made by analogous methods (WO 2004/084326).

In other embodiments, one or more of R₁ to R₈ in formula I may be a substituent containing a spiro group, such as, for example, a spirobifluorenyl group. In specific embodiments, the substituted 2-phenylpyridine group may have the following structures:

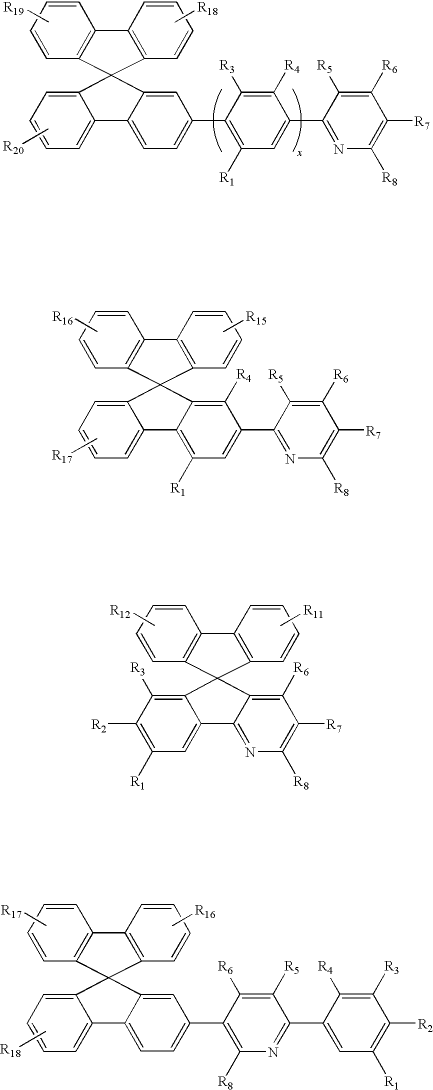

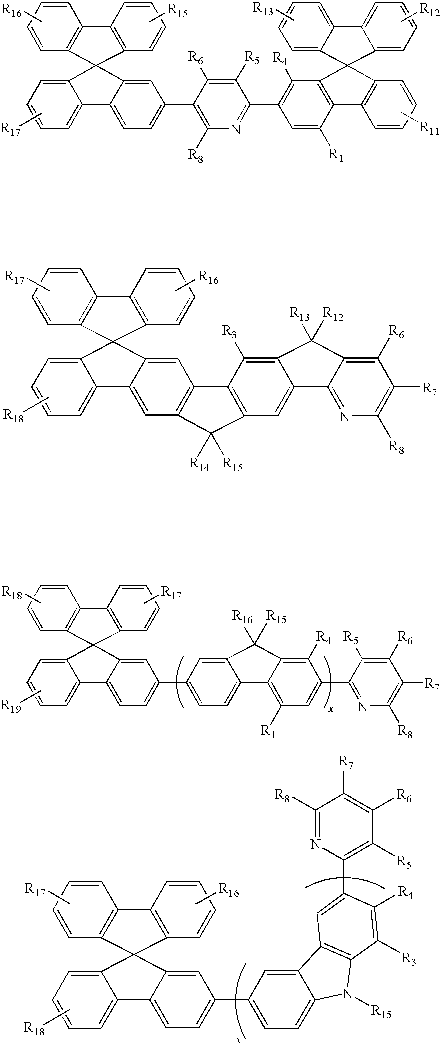

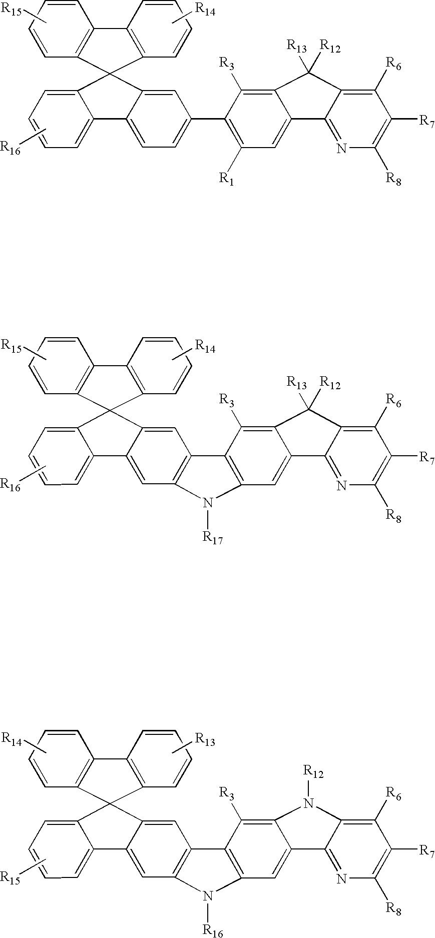

wherein R₁₁ to R₂₀ are independently defined as R₁ above and wherein x may be 1 to about 3.

Spiro substituted 2-phenylpyridine groups may be prepared with satisfactory yields by methods known in the art. For example, spirobifluorenyl containing ligands may be prepared by reacting fluorenone with a Grignard reagent or a lithium reagent of 2-bromobiphenyl, followed by acid treatment (Yu, et al, Adv. Mater. 2000, 12, 828-831; Katsis et al., Chem. Mater. 2002, 14, 1332-1339). If this spiro-bifluorenyl group contains an additional functional group, for example, a halogen group, it may be further coupled with other reagent through Grignard reaction, Stille coupling reaction, Suzuki coupling reaction, or zinc coupling reaction to get the desired ligands. Spiro silicon substituents may be prepared according to methods known in the art, for example, as described in U.S. Pat. No. 6,461,748, and coupled to 2-phenylpyridine by known methods.

Following the same procedure as described above, spiro-substituted 2-phenylpyridine groups may be reacted with iridium chloride to afford the chloro-bridged dimer which may then be reacted with another ligand (L) to yield a phosphorescent complex of the invention. Alternatively, the spiro-substituted 2-phenylpyridine groups may be reacted with a chloro-bridged L dimer, such as, for example, L₂Ir(Cl)₂IrL₂ to yield a phosphorescent complex of the invention.

As would be appreciated by person skilled in the ark the identity of R₁-R₈ may influence the electronic, and therefore luminescent, properties of the organometallic complexes. Non-conjugated substituents may influence light emission due to different conjugation lengths relative to conjugated substituents. For example, the emission spectrum of Ir(ppy)-based phosphor may be modified by the incorporation of electron donating or electron withdrawing substituents. US 2002/0182441 discloses bis 4-6 fluoro derivatives of (ppy)₂Ir(acac) whose photoluminescence emission is blueshifted relative to ppy₂Ir(acac). Introducing perfluorophenyl groups onto (ppy)₂Ir(acac) may red or blue shift the emission maximum, depending on the position of the substitution (Ostrowski et al., 2002, Chem. Commun., 7: 784-785. Nazeeruddin et al., 2003, J. Amer. Chem. Soc. 125: 8790-8797; Lamansky et al., 2001, J. Amer. Chem. Soc. 123: 4304-4312; NHK Laboratories Note No. 484 available online at www.nhk.or.jp/strl/publica/labnote/lab484.html.

Solutions of the organometallic complex of formula I may be made by dissolving the complex in a suitable solvent. In some embodiments, the solution further comprises a charge-carrying host material. The solvent is preferably a solvent in which both the organometallic complex and the host are sufficiently soluble. In some embodiments, the solvent is a volatile organic that is amenable to solution processing techniques such as, for example, spin coating.

Phosphorescent complexes comprising branched substituted 2-phenylpyridine-based ligands differ from phosphorescent dendrimeric complexes disclosed, for example, in WO 03/079736, US 2004/0137263, WO 2004/020448 and WO 02/066552, in that the dendrons of the latter are generally attached at only one or two positions of the 2-phenylpyridine ring.

Films of the organometallic complex of formula I may be prepared by conventional solution processing techniques, such as, for example, spin coating or ink jet printing. In some embodiments, the organometallic compounds of formula I may be combined with a organic or polymeric charge-carrying host compound, and solutions comprising the host and guest materials processed into a film by solution processing techniques (Lee et al. 2000, Appl Phys Lett. 81(1):1509).

As would be appreciated by a person skilled in the art, the charge-carrying host material may be selected to allow efficient exciton transfer to the organometallic complex with little or no back transfer from a triplet state of phosphorescent emitting centers to a triplet of the host. The person skilled in the art would be aware of a number of known host materials including, but not limited to, 3-phenyl-4(1′napthyl)-5-phenyl-1,2,4-triazole (“TAZ”), 4,4′-N,N dicarbazole-biphenyl (“CBP”), poly-9-vinylcarbazole (“PVK”), 2-(4-biphenyl)-5(4-tertbutyl-phenyl)-1,3,4,oxadiazole (“PBD”), 4,4′,4″-tri-N-carbazolyl-(triphenylamine) (“TCTA”), 1,3,4-oxadiazole,2,2′-(1,3-phenylene)bis[5-[4-(1,1-dimethylethyl)phenyl]] (“OXD-7”) or poly[2-(6-cyano-6-methyl)heptyloxy-1,4-phenylene (“CNPP”)

The HOMO and LUMO energies of a number of host materials are known (Anderson et al 1998, J. Am. Chem. Soc. 120:9496; Gong et al 2003, Adv. Mat. 15:45). Alternatively, HOMO an LUMO energies of a material may be determined by methods known in the art (Anderson et al 1998, J. Am. Chem. Soc. 120:9496; Lo et al. 2002, Adv. Mat. 14:975).

In one embodiment, the organometallic complex may be added to the host in molar ratios of about 1% to about 50%. Depending on the desired properties of the film, a person skilled in the art would know how much of the organometallic complex to include within the host material. Generally, the absorption spectra of the film should show emission principally from the phosphor and little or no emission from the host material. At greater organometallic complex concentrations, bimolecular complex-complex interaction may quench emission at high exciton densities (Baldo et al. 1998, Nature 395: 151). Depending on the desired luminescent properties, the concentration of the organometallic complex may be appropriately varied. For example, the concentration of the organometallic complex may be selected to show the maximum luminescence with no or little roll-off at higher current densities. For Ir(ppy)₃ complexes, peak efficiencies in CBP and PVK hosts are obtained at complex concentrations of about 6 and about 8 mass percent, respectively (Baldo et al (1999) Pure Appl. Chem. 71(11):2095; Lee et al Appl Phys Lett 2000, 77(15):2280).

It is believed that blending the phosphorescent organometallic complex into a host may improve the quantum efficiency of the phosphorescent emitter by separating emissive centers. An Ir(ppy)₃-dendrimer film had a only a 22% photoluminescent quantum yield (PLQY) in the solid state, whereas the same dendrimer doped at a weight ratio of 20% into CBP has a PLQY of 79±6%, indicating that efficient energy transfer occurs from the CBP host to the Ir(ppy)₃-based dendrimer and the increased separation of the phosphorescent chromophores minimizes T-T-annihilation (Lo et al 2002, Advanced Materials 14:975).

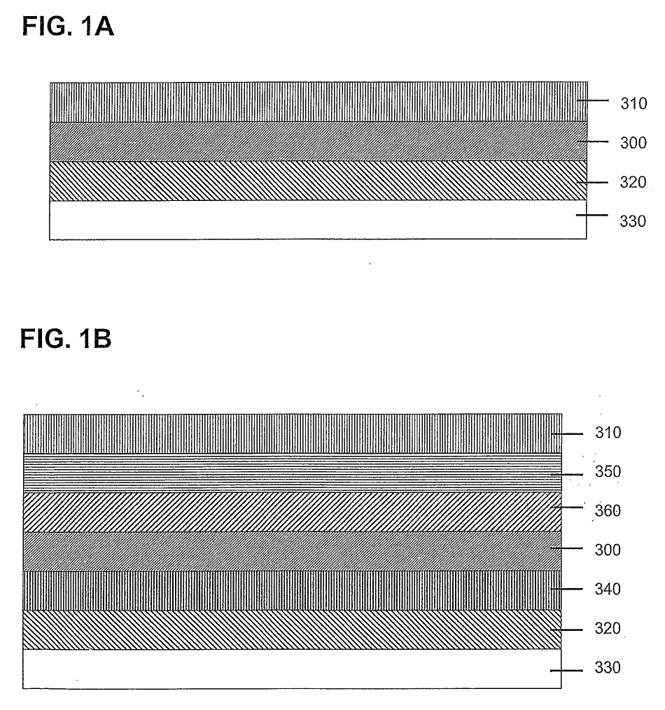

Films comprising an organometallic complex of formula I may be advantageously used in electroluminescent devices. As will be appreciated by a skilled person, generally, and with reference to FIG. 1A (which is not depicted to scale), electroluminescent devices comprise an emissive layer (300) comprising one or more electroluminescent materials disposed between an electron injecting cathode (310) and a hole injecting anode (320). In certain embodiments, one or more of the anode and the cathode may be deposited on a support (330), which may be transparent, semi-transparent or translucent. As would be understood by a person skilled in the art, the anode or the cathode may be transparent, semi-transparent or translucent, and the transparent, semi-transparent or translucent electrode may be disposed on a transparent) semi-transparent or translucent support. In certain embodiments, the anode is transparent, semi-transparent or translucent and is disposed on a transparent semi-transparent or translucent support.

The anode (320) may be a thin film of gold or silver, or more preferably indiumtinoxide (ITO). Generally the anode comprises a metal with a high work function (US 2002/0197511). ITO is particularly suitable as an anode due to its high transparency and electrical conductivity. In various embodiments, the anode (320) may be provided on a transparent semi-transparent or translucent support (330).

In certain embodiments, one or more of the anode and the cathode may be deposited on a support (330), which may be transparent, semi-transparent or translucent. The transparent, semi-transparent or translucent support (330) may be rigid, for example quartz or glass, or may be a flexible polymeric substrate. Examples of flexible transparent semi-transparent or translucent substrates include, but are not limited to, polyimides, polytetrafluoroethylenes, polyethylene terephthalates, polyolefins such as polypropylene and polyethylene, polyamides, polyacrylonitrile and polyacrionitrile, polymethacrylonitrile, polystyrenes, polyvinyl chloride, and fluorinated polymers such as polytetrafluoroethylene.

The emissive layer (300) comprising the organometallic complex of formula I hereinafter also referred to as a “guest” or “acceptor”) may be provided as a film on the anode by known solution processing techniques such as, for example, spin coating, casting, microgravure coating, gravure coating, bar coating, roll coating, wire bar coating, dip coating, spray coating, screen printing, flexo printing, offset printing or inkjet printing. In certain embodiments, the emissive layer further comprises an organic charge-carrying host material. The charge-carrying host material plays important roles in charge transport and acts as a triplet source to transfer excited triplets to the metal for emission (WO 03/079736).

The charge-carrying host material may be predominantly a electron transporting material, such as, for example Alq3, TAZ, BCP, PBD, OXD-7, or predominantly a hole transporting material such as, for example, N,N′-diphenyl-N,N-bis(3-methylphenyl1)1,1′-biphenyl-4,4′ diamine (“TPD”), PVK, TCTA or N,N′-Bis(naphthalen-1-yl)-N,N-bisphenyl)benzidine (“NPB”). Additional hole transporting materials may be found in U.S. Pat. No. 6,097,147.

In certain embodiments, the electroluminescent polymer film may have a thickness of about 50 to 200 nm. A skilled person would readily appreciate how to control the thickness of the resulting film by, for example, controlling the duration of coating or the amounts of the electroluminescent polymer. In certain embodiments, the charge-carrying host material may comprise a combination of charge carriers, for example, a blend of PVK and PBD (Lim et al 2003, Chem Phys Lett 376:55). As will be understood by a skilled person, the emissive layer need not be of uniform composition and may itself be made up of a number of distinct layers (US 2003/0178619).

In some embodiments the emissive layer (300) may also contain a fluorescence emitting material, such as, for example, [2-methyl-6-[2,3,6,7-tetrahydro-1H,5H-benzo[ij]quinolizin-9-yl)ethenyl]-4H-pyran-4-ylidene] propane-dinitrile (“DCM2”) (US2003/0178619) or Nile Red (He et al 2002, Appl. Phys. Lett 81(8):1509). Electroluminescent devices comprising an emissive layer of 1% (ppy)₂Ir(acac) and 1% Nile Red in PVK:PBD shows almost exclusive emission from the Nile Red fluorophore. Without being limited to any particular theory, it is believed that organometallic complexes of formula I may act as intersystem crossing agents, allowing triplet states formed during exciton recombination to be transferred as singlet states to the fluorescent emitting material through Förster transfer. In this embodiment, the intersystem crossing agent and fluorescence emitting material may be present within distinct layers within the emissive layer. Preferably, the intersystem crossing agent and fluorescence emitting material are selected such that there is substantial spectral overlap between the fluorescence emitter and the intersystem crossing agents, and between the emissive spectra of the host material and the absorption spectra of the intersystem crossing agent (US 2003/0178619). Substantial spectral overlap may be calculated, for example, as described in US 2003/0178619.

The relative concentration of the guest material within the charge-carrying host material within the emissive layer (300) may be about 0.5 to about 20 weight percent. A person skilled in the art would appreciate that the optimal concentration of the guest in a given host may be determined by known methods, for example by comparing the luminescent properties of devices that differ only in the concentration of the phosphorescent guest. Generally, the optimal concentration of the phosphorescent guest is a concentration that gives a desired level of luminescence at a given current density without a significant roll-off in quantum efficiency.

The cathode (310) may be any material capable of conducting electrodes and injecting them into organic layers. The cathode may be a low work function metal or metal alloy, including, for example, barium, calcium, magnesium, indium, aluminum, ytterbium, an aluminum:lithium alloy, or a magnesium:silver alloy, such as, for example an alloy wherein the atomic ratio of magnesium to silver is about 10:1 (U.S. Pat. No. 6,791,129) or an alloy where the atomic ratio of lithium to aluminum is about 0.1:100 to about 0.3:100 (Kim et al. (2002) Curr. Appl. Phys. 2(4):335-338; Cha et al (2004) Synth. Met. 143(1): 97; Kim et al (2004) Synth. Met. 145(2-3): 229). The cathode (310) may be a single layer or have a compound structure. The cathode (310) may be reflective, transparent or translucent.

With reference to FIG. 1B, the electroluminescent device may further contain one or more of a hole injecting layer (HL) (340) disposed between the anode (320) and the emissive layer (300), a hole blocking layer (360) disposed between the emissive layer and the cathode (310), and an electron transport layer (ETL) (350) disposed between the hole blocking layer (360) and the cathode (310). As would be appreciated by a person skilled in the art, the electroluminescent device may be prepared by combining different layers in different ways, and other layers not specifically described or depicted in FIG. 1B may also be present. The thicknesses of the layers in FIG. 1B are also not depicted to scale.

The ETL (350) comprises an electron transporting material. As used herein, an electron transporting material is a any material that allows for the efficient injection of electrons from the cathode (310) into the LUMO of the electron transport layer material. The ETL may comprise an inherent electron transporting material, such as, for example Alq3, or a doped material such as, for example, the Li doped BPhen disclosed in US 2003 0230980. Preferably, the work function of the cathode is not more than about 0.75 eV greater than the LUMO level of the electronic transporting material more preferably not more than about 0.5 eV, or even more preferably, about 0.5 eV less than the LUMO level of the electron transporting material (US2003/0197467). In certain embodiments the electron transporting layer may have a thickness of about 10 nm to about 100 nm.

The HIL (340) comprises a hole injecting material. Hole injection materials are materials that can wet or planarize the anode to allow for the efficient injection of holes from the cathode into the hole injection layer (US2003/0197467). Hole injection materials are generally hole-transporting materials, but are distinguished in that they generally have hole mobilities substantially less than conventional hole transporting materials. Hole injecting materials include, for example, 4,4′,4″-tris(3-methylphenylphenylamino)triphenylamine (“m-MT-DATA”) (US2003/0197467), poly(enthylendioxythiophene):poly(styrene sulfonic acid) (“PEDOT:PSS”) or polyanaline (“PANI”). In certain embodiments, the hole injection layer may have a thickness of about 20 nm to about 100 nm.

In certain embodiments, the efficiency of OLED devices may be improved by incorporating a hole blocking layer (360). Without being limited to any particular theory, it is believed that the HOMO level of the hole blocking material prevents the charges from diffusing out of the emissive layer but the hole blocking material has a sufficiently low electron barrier to allow electrons to pass through the hole blocking layer (360) and enter the emissive layer (300) (see, for example, U.S. Pat. Nos. 6,097,147, 6,784,106 and US 20030230980). Hole blocking materials would be known to a person skilled in the art, and include, for example, 2,9-dimethyl-4,7-diphenyl-1,10-phenanthroline (“BCP”). Generally the hole blocking layer (360) is thinner than the charge carrier layers, such as ETL (350) (2004/0209115). In some embodiments, the hole blocking layer may have a thickness of about 5 nm to about 30 nm.

The host material in the emissive layer (300) may be an exciton blocking material. In phosphorescent devices, the excitons are believed to primarily reside on the host and are eventually transferred to the phosphorescent guest sites prior to emission (US 2002/0182441). Exciton blocking materials will generally have a larger bandgap than materials in the adjacent layers. Generally, excitons do not diffuse from a material having a lower band gap into a material having a higher bandgap and an exciton blocking material may be used to confine the excitons within an emissive layer (U.S. Pat. No. 6,784,016). For example, the deep HOMO level of CBP appear to encourage hole trapping on Ir(ppy)₃ (US 2002/0182441). The phosphorescent guest may itself serve as a hole-trapping materials where the ionization potential of the phosphorescent guest is greater than that of the host material

In addition to the layers described in FIG. 1B, the electroluminescent device may also contain one or more of the following layers: a electron injecting layer disposed on the cathode. As used herein an electron injection material is any material that can efficiently transfer electrons from the cathode to an electron transport layer. Electron injecting materials would be known to a person skilled in the art and include, for example, LiF or LiF/Al. The electron injecting layer generally may have a thickness much smaller than the thickness of the cathode or of the adjacent electron transporting layer and may have a thickness of about 0.5 nm to about 5.0 nm.

As will be appreciated from the above, a material may serve more than one function in an electroluminescent device. For example, electron transporting materials with a sufficiently large band gap may also serve as a hole blocking layer. Dual-function materials would be known to a person skilled in the art and include, for example, TAZ, PBD and the like.

A person skilled in the art would know how to select the appropriate host material. For instance, it would be appreciated that the LUMO level of the host material should be sufficiently greater than the LUMO level of the phosphorescent guest to prevent back-transfer of excited triplet states to the host. Furthermore, it would also be appreciated that the emission spectra of the host should overlap the absorption spectra of the phosphorescent guest.

The above-mentioned layers may be prepared by methods known in the art. In certain embodiments, emissive layer (300) is prepared by solution processing techniques such as, for example, spin coating or inkjet printing (U.S. Pat. No. 6,013,982; U.S. Pat. No. 6,087,196). Solution coating steps may be carried out in an inert atmosphere, such as, for example, under nitrogen gas. Alternatively, layers may be prepared by thermal evaporation or by vacuum deposition. Metallic layers may be prepared by known techniques, such as, for example, thermal or electron-beam evaporation, chemical-vapour deposition or sputtering.

The ability of compounds of the present invention to prevent T-T annihilation or concentration quenching may be determined by methods known in the art. As mentioned above, the roll-off of quantum efficiency of electroluminescent devices at higher current densities is a characteristic of T-T annihilation. Alternatively, the steady state photoluminescence of a film containing a phosphorescent guest may be compared to the photoluminescence of the guest in solution.

All documents referred to herein are fully incorporated by reference.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. All technical and scientific terms used herein have the same meaning as commonly understood by one of ordinary skill in the art of this invention, unless defined otherwise.

The word “comprising” is used as an open-ended term, substantially equivalent to the phrase “including, but not limited to”. Singular articles such as “a” and “the” in the specification incorporate, unless the context dictates otherwise, both the singular and the plural.

The following examples are illustrative of various aspects of the invention, and do not limit the broad aspects of the invention as disclosed herein.

### EXAMPLES

### Example 1

### Synthesis of 2-(trimethylsilyl)pyridine (Compound 1)

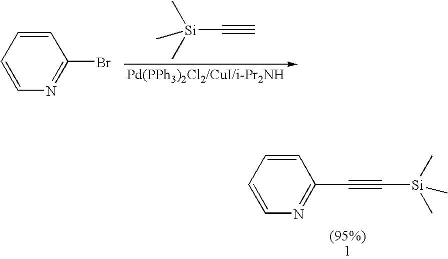

To a solution of 2-bromopyridine (4.74 g, 0.030 mol), CuI (0.14 g, 0.74 mmol), and Pd(PPh₃)₂Cl₂ (0.52 g, 0.74 mmol) in 100 ml of diisopropylamine was added (trimethylsilyl)acetylene (3.0 g, 0.030 mol). The mixture was stirred at room temperature overnight under nitrogen atmosphere. After removal of the solvent under reduce pressure, the residue was purified by reduced pressure distillation to offer 5.0 g (yield 95%) of pure compound 1 of 2-trimethylsilyl)pyridine.

### Example 2

### Synthesis of 2-(trimethylsilyl)-5-bromopyridine (Compound 2)

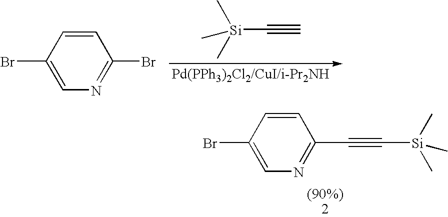

To a solution of 2,5-dibromopyridine (3.56 g, 0.015 mol), CuI (0.07 g, 0.37 mmol), and Pd(PPh₃)₂Cl₂ (0.26 g, 0.37 mmol) in 100 ml of diisopropylamine was added (trimethylsilyl)acetylene (1.47 g, 0.015 mol). The mixture was stirred at room temperature overnight under nitrogen atmosphere. After removal of the solvent under reduce pressure, the residue was purified by flash column to offer 3.45 g (yield 90%) of compound 2 of 2-trimethylsilyl)-5-bromopyridine.

### Example 3

### Synthesis of 2-(2′,3′,4′,5′-tetraphenyl)phenyl-5-bromopyridine (Compound 3)

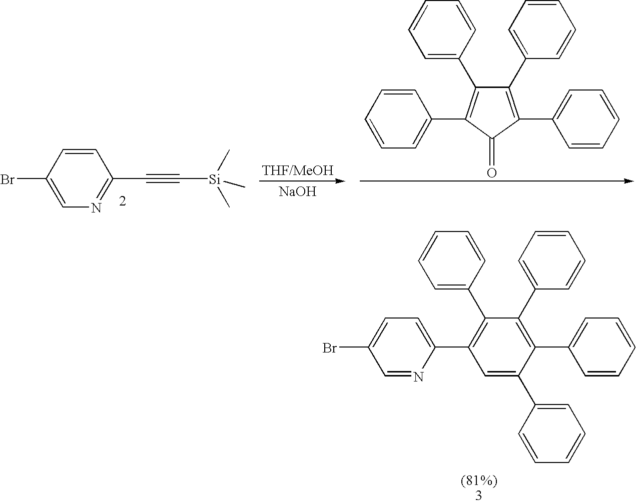

To a solution of 2-(trimethylsilyl)-5-bromopyridine (1.27 g, 5 mmol) in the mixture of THF and methanol was added 1 ml of NaOH (5N). The reaction mixture was stirred for 1 hour at room temperature. Then 50 ml of ethyl acetate was added, the mixture was washed with water and brine and dried with anhydrous magnesium sulfate. After removal of the solvent, the residue was refluxed with tetraphenylcyclopentadienone (2 g, 5.2 mmol) in 50 ml of o-xylene overnight. After cooled down to room temperature, the solvent was removed by flash column and the residue was purified by recrystallization in ethanol 2-3 times to offer 2.17 g (yield 81%) of pure 2-(2′,3′,4′,5′-tetraphenyl)phenyl-5-bromopyridine (Compound 3).

### Example 4

### Synthesis of Compound 4

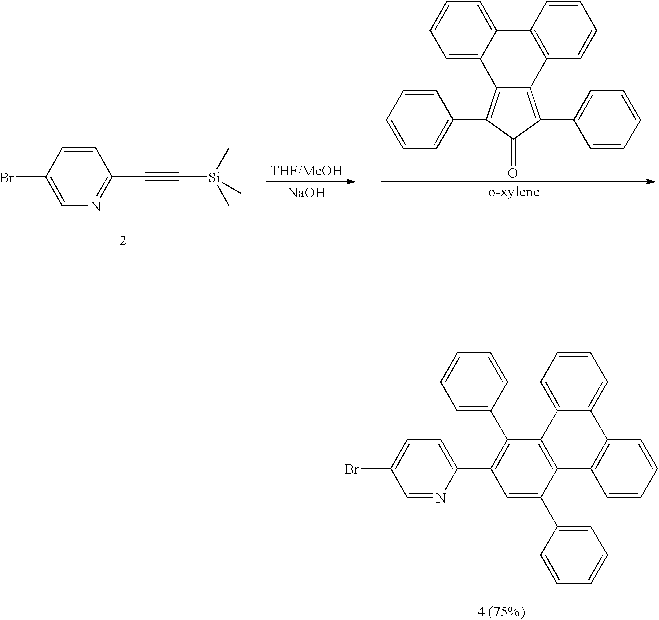

To a solution of 2-(trimethylsilyl)-5-bromopyridine (1.27 g, 5 mmol) in the mixture of THF and methanol was added 1 ml of NaOH (5N). The reaction mixture was stirred for 1 hour at room temperature. Then 50 ml of ethyl acetate was added, the mixture was washed with water and brine and dried with anhydrous magnesium sulfate. After removal of the solvent, the residue was refluxed with cyclotone (2 g, 5.2 mmol) in 50 ml of o-xylene overnight. After cooled down to room temperature, the solvent was removed by flash column and the residue was purified by recrystallization in ethanol 2-3 times to offer 2.00 g (yield 75%) of pure Compound 4.

### Example 5

### Synthesis of 2-(2′,3′,4′,5′-tetraphenyl)phenylpyridine (A)

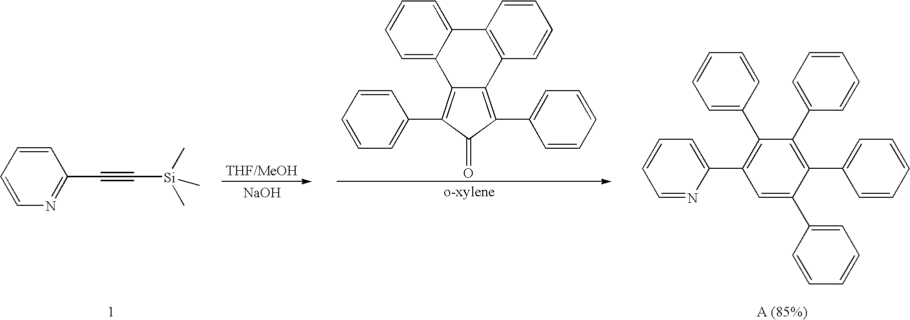

To a solution of 2-(trimethylsilyl)pyridine (0.88 g, 5 mmol) in the mixture of THF and methanol was added 1 ml of NaOH (5N). The reaction mixture was stirred for 1 hour at room temperature. 50 ml of ethyl acetate was added, the mixture was washed with water and brine and dried with anhydrous magnesium sulfate. After the removal of the solvent, the residue was refluxed with tetraphenylcyclopentadienone (2 g, 5.2 mmol) in 50 ml of o-xylene overnight. After cooled down to room temperature, the solvent was removed by flash column and the crude product was purified by recrystallization in ethanol 2-3 times to offer 1.95 g (yield 85%) of pure 2-(2′,3′,4′,5′-tetraphenyl)phenylpyridine (A).

### Example 6

### Synthesis of B

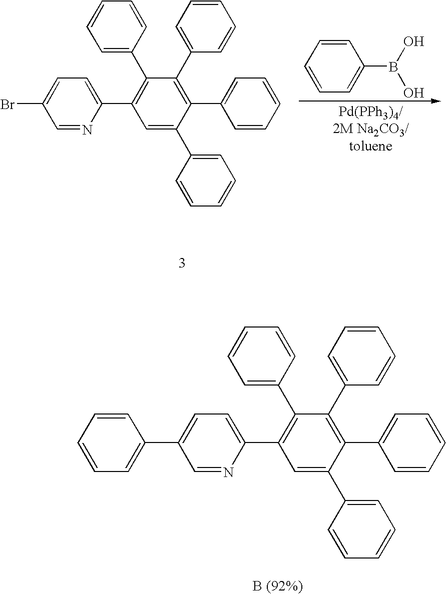

In an argon flushed two-neck round-bottom flask, a mixture of 1.60 g (3.0 mmol) of Compound 3, 0.5 g (4 mmol) of phenyl boronic acid, 36 mg (1 mol %) of tetrakis(triphenylphosphine)palladium(0), 15 ml of 2 M sodium carbonate and 30 ml of toluene was added and heated at reflux for two hours. After cooling down, the reaction mixture was extracted with ethyl acetate and the organic phase was washed with brine and dried over magnesium sulfate. After the solvent was removed on a rotary evaporator, the residue was purified by flash column eluted with hexane/CH₂Cl₂ (3:1) followed by recrystallization in ethanol to provide 1.48 g of B (yield 92%).

### Example 7

### Synthesis of C

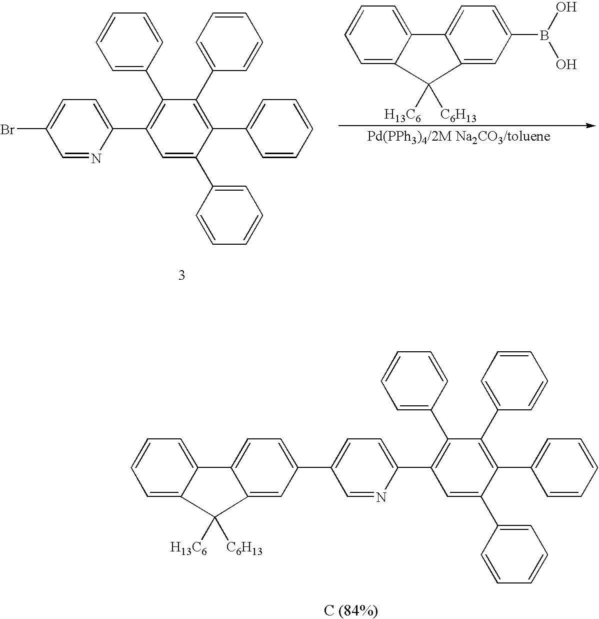

In an argon flushed two-neck round-bottom flask, a mixture of 1.60 g (3.0 mmol) of Compound 3, 1.51 g (4 mmol) of compound 2-(9,9-dihexyl)-fluorenyl boronic acid, 36 mg (1 mol %) of tetrakis(triphenylphosphine)palladium(0), 15 ml of 2 M sodium carbonate and 30 ml of toluene was added and heated at reflux for two hours. After cooling down, the reaction mixture was extracted with ethyl acetate and the organic phase was washed with brine and dried over magnesium sulfate. After the solvent was removed on a rotary evaporator, the residue was purified by flash column eluted with hexane/CH₂Cl₂ (4:1) followed by recrystallization in ethanol to provide 1.99 g of C (yield 84%).

### Example 8

### Synthesis of D

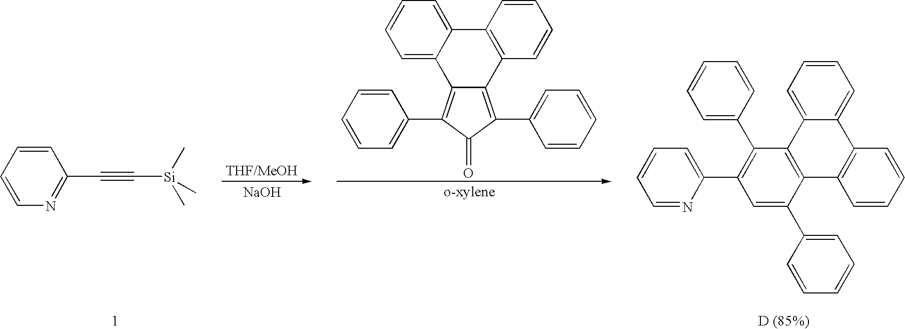

To a solution of 2-(trimethylsilyl)pyridine (0.88 g, 5 mmol) in the mixture of THF and methanol was added 1 ml of NaOH (5N). The reaction mixture was stirred for 1 hour at room temperature. Then 50 ml of ethyl acetate was added, the mixture was washed with water and brine and dried with anhydrous magnesium sulfate. After the removal of the solvent, the residue was refluxed with cyclotone (2 g, 5.2 mmol) in 50 ml of o-xylene overnight. After cooled down to room temperature, the solvent was removed by flash column and the residue was purified by recrystallization in ethanol 2-3 times to offer 1.95 g (yield 85%) of D.

### Example 9

### Synthesis of E

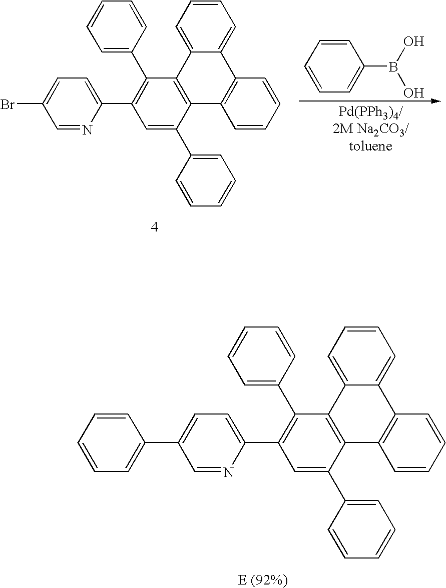

In an argon flushed two-neck round-bottom flask, a mixture of 1.60 g (3.0 mmol) of Compound 4, 0.5 g (4 mmol) of phenyl boronic acid, 36 mg (1 mol %) of tetrakis(triphenylphosphine)palladium(0), 15 ml of 2 M sodium carbonate and 30 ml of toluene was added and heated at reflux for two hours. After cooling down, the reaction mixture was extracted with ethyl acetate and the organic phase was washed with brine and dried over magnesium sulfate. After the solvent was removed on a rotary evaporator, the residue was purified by flash column eluted with hexane/CH₂Cl₂ (3:1) followed by recrystallization in ethanol to provide 1.43 g of E (yield 92%).

### Example 10

### Synthesis of F

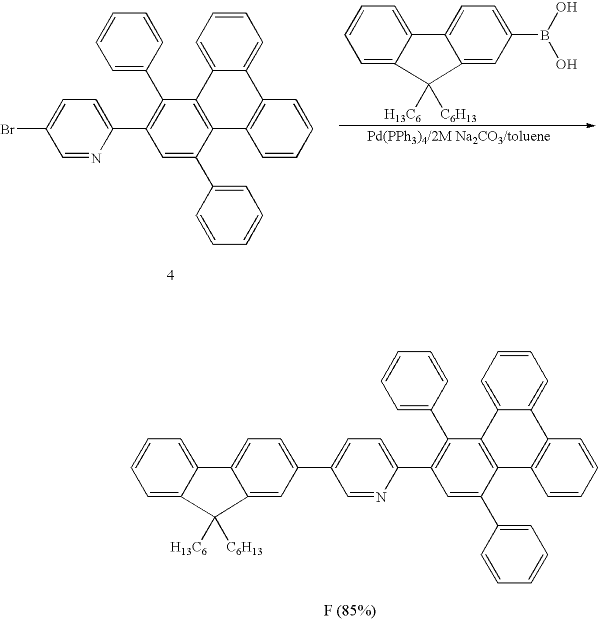

In an argon flushed two-neck round-bottom flask, a mixture of 1.60 g (3.0 mmol) of Compound 4, 1.51 g (4 mmol) of 2-(9,9-dihexyl)-fluorenyl boronic acid, 36 mg (1 mol %) of tetrakis(triphenylphosphine)palladium(0), 15 ml of 2 M sodium carbonate and 30 ml of toluene was added and heated at reflux for two hours. After cooling down, the reaction mixture was extracted with ethyl acetate and the organic phase was washed with brine and dried over magnesium sulfate. After the solvent was removed on a rotary evaporator, the residue was purified by flash column eluted with hexane/CH₂Cl₂ (4:1) followed by recrystallization in ethanol to provide 2.0 g of F (yield 85%).

### Example 11

### Synthesis of A₂IrCl₂IrA₂

In 30 ml of a mixture of 2-ethoxyethanol and water (3:1), 0.2 g (0.57 mmol) IrCl₃.nH₂O and 0.67 g (1.45 mmol) A were added. The reaction mixture was refluxed overnight. Then the mixture was filtrated when cooled down to room temperature and washed with water and ethanol. 0.51 g pale yellow solid of bridge compound A were obtained after dried under vacuum (yield 78%).

### Example 12

### Synthesis of B₂IrCl₂IrB₂

In 30 ml of a mixture of 2-ethoxyethanol and water (3:1), 0.2 g (0.57 mmol) IrCl₃.nH₂O and 0.77 g (1.45 mmol) B were added. The reaction mixture was refluxed overnight. The mixture was filtrated when cooled down to room temperature and washed with water and ethanol. 0.50 g orange powder of bridge compound B were obtained after dried under vacuum (yield 68%).

### Example 13

### Synthesis of C₂IrCl₂IrC₂

In 30 ml of a mixture of 2-ethoxyethanol and water (3:1), 0.2 g (0.57 mmol) IrCl₃.nH₂O and 1.15 g (1.45 mmol) C were added. The reaction system was refluxed overnight. Then the mixture was filtrated when cooled down to room temperature and washed with water and ethanol. 0.73 g orange solid of bridge compound C were obtained after dried under vacuum (yield 71%).

### Example 14

### Synthesis of D₂IrCl₂IrD₂

In 30 ml of a mixture of 2-ethoxyethanol and water (3:1), 0.2 g (0.57 mmol) IrCl₃.nH₂O and 0.67 g (1.45 mmol) D were added. The reaction system was refluxed overnight. Then the mixture was filtrated when cooled down to room temperature and washed with water and ethanol. 0.44 g pale yellow solid of bridge compound D were obtained after dried under vacuum (yield 68%).

### Example 15

### Synthesis of E₂IrCl₂IrE₂

In 30 ml of a mixture of 2-ethoxyethanol and water (3:1), 0.2 g (0.57 mmol) IrCl₃.nH₂O and 0.77 g (1.45 mmol) E were added. The reaction system was refluxed overnight. Then the mixture was filtrated when cooled down to room temperature and washed with water and ethanol 0.52 g orange solid of bridge compound E were obtained after dried under vacuum (yield 71%).

### Example 16

### Synthesis of F₂IrCl₂IrF₂

In 30 ml of a mixture of 2-ethoxyethanol and water (3:1), 0.2 g (0.57 mmol) IrCl₃.nH₂O and 1.15 g (1.45 mmol) F were added. The reaction system was refluxed overnight. Then the mixture was filtrated when cooled down to room temperature and washed with water and ethanol. 0.77 g orange solid of bridge compound F were obtained after dried under vacuum (yield 75%).

### Example 17

### Synthesis of A₂Ir(acac)

In an argon flushed two-neck round-bottom flask, a mixture of 0.23 g (0.1 mmol) of bridge compound A, 0.1 g (1 mmol) of 2,4-pentanedione in 1 ml ethanol, 0.5 ml tetramethylammoniumhydroxide (25% in methanol), and 30 ml of CH₂Cl₂ was added and heated at reflux for 5 hours. After cooling down, the reaction mixture was washed with brine and dried over magnesium sulfate. After the solvent was removed on a rotary evaporator, the residue was purified by recrystallization in heptane to provide 190 mg of A₂Ir(acac) (yield 79%).

### Example 18

### Synthesis of B₂Ir(acac)

In an argon flushed two-neck round-bottom flask, a mixture of 0.26 g (0.1 mmol) of bridge compound B, 0.1 g (1 mmol) of 2,4-pentanedione in 1 ml ethanol, 0.5 ml tetramethylammoniumhydroxide (25% in methanol), and 30 ml of CH₂Cl₂ was added and heated at reflux for 5 hours. After cooling down, the reaction mixture was washed with brine and dried over magnesium sulfate. After the solvent was removed on a rotary evaporator, the residue was purified by recrystallization in heptane to provide 192 mg of B₂Ir(acac) (yield 71%).

### Example 19

### Synthesis of C₂Ir(acac)

In an argon flushed two-neck round-bottom flask, a mixture of 0.36 g (0.1 mmol) of bridge compound C, 0.1 g (1 mmol) of 2,4-pentanedione in 1 ml ethanol, 0.5 ml tetramethylammoniumhydroxide (25% in methanol), and 30 ml of CH₂Cl₂ was added and heated at reflux for 5 hours. After cooling down, the reaction mixture was washed with brine and dried over magnesium sulfate. After the solvent was removed on a rotary evaporator, the residue was purified by recrystallization in heptane to provide 274 mg of C₂Ir(acac) (yield 73%).

### Example 20

### Synthesis of D₂Ir(acac)

In an argon flushed two-neck round-bottom flask, a mixture of 0.23 g (0.1 mmol) of bridge compound A, 0.1 g (1 mmol) of 2,4-pentanedione in 1 ml ethanol, 0.5 ml tetramethylammoniumhydroxide (25% in methanol), and 30 ml of CH₂Cl₂ was added and heated at reflux for 5 hours. After cooling down, the reaction mixture was washed with brine and dried over magnesium sulfate. After the solvent was removed on a rotary evaporator, the residue was purified by recrystallization in heptane to provide 158 mg of D₂Ir(acac) (yield 66%).

### Example 21

### Synthesis of E₂Ir(acac)

In an argon flushed two-neck round-bottom flask, a mixture of 0.26 g (0.1 mmol) of bridge compound E, 0.1 g (1 mmol) of 2,4-pentanedione in 1 ml ethanol, 0.5 ml tetramethylammoniumhydroxide (25% in methanol), and 30 ml of CH₂Cl₂ was added and heated at reflux for 5 hours. After cooling down, the reaction mixture was washed with brine and dried over magnesium sulfate. After the solvent was removed on a rotary evaporator, the residue was purified by recrystallization in heptane to provide 220 mg of E₂Ir(acac) (yield 81%).

### Example 22

### Synthesis of F₂Ir(acac)

In an argon flushed two-neck round-bottom flask, a mixture of 0.36 g (0.1 mmol) of bridge compound F, 0.1 g (1 mmol) of 2,4-pentanedione in 1 ml ethanol, 0.5 ml tetramethylammoniumhydroxide (25% in methanol), and 30 ml of CH₂Cl₂ was added and heated at reflux for 5 hours. After cooling down, the reaction mixture was washed with brine and dried over magnesium sulfate. After the solvent was removed on a rotary evaporator, the residue was purified by recrystallization in heptane to provide 262 mg of F₂Ir(acac) (yield 70%).

### Example 23

### Synthesis of 4,4′-di-tert-butylbiphenyl (5)

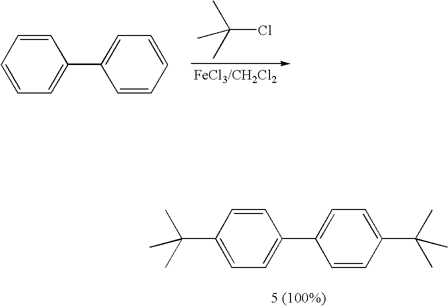

To a stirred solution of biphenyl (15.4 g, 100 mmol) and anhydrous ferric chloride (80 mg) in dichloromethane (100 ml) at room temperature was added slowly tert-butyl chloride (23.2 ml, 216 mmol). The reaction was stirred overnight. The product was washed with water and extracted with hexane (100 ml) 3 times. The combined organic phase was washed with brine, dried over anhydrous MgSO₄ and concentrated in vacuo and gave 26.6 g of Compound 5 (yield 100%). ¹H NMR (400 MHz, chloroform-d): δ, ppm 7.542 (d, 4H), 7.444 (d, 4H), 1.365 (s, 18H).

### Example 24

### Synthesis of 2-bromo-4,4′-di-tert-butylbiphenyl (6)

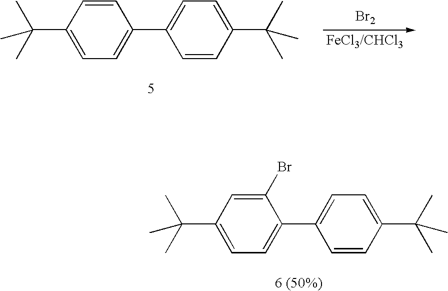

To a solution of 4,4′-di-tert-butylbiphenyl (3.99 g, 15 mmol) and anhydrous ferric chloride (20 mg) in chloroform (30 ml) at 0° C. was added dropwise bromine (2.4 g, 15 mmol) solved in chloroform (10 ml). The reaction was stirred overnight. The reaction mixture was quenched with sodium carbonate until the orange color disappeared. Then washed with water and extracted with hexane (50 ml) 3 times. The combined organic phase was washed with brine, dried over anhydrous MgSO₄ and concentrated in vacuo. ¹HNMR measurement indicated that the conversion ratio is about 50%. The crude product was directly used for further reaction.

### Example 25

### Synthesis of 2-bromo-9-fluorenone (7)

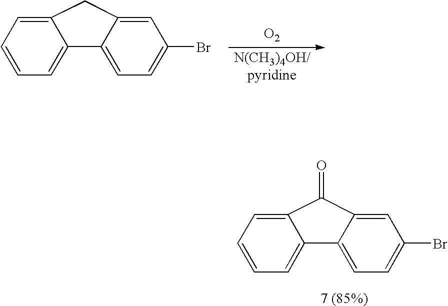

To a solution of 2-bromofluorene (9.8 g, 40 mmol) in pyridine (100 ml), 25% tetramethylammonium hydroxide in methanol (1 ml) was added at room temperature. Then air was bubbled into the system and kept the reaction stirring overnight. Then H₂SO₄ was added and filtrated. The solid was recrystallized in ethanol to give yellow needles 8.85 g (85%)

### Example 26

### Synthesis of 2-bromo-(2′,7′-ditert-butyl)-9,9′-spiro-bifluorene (8)

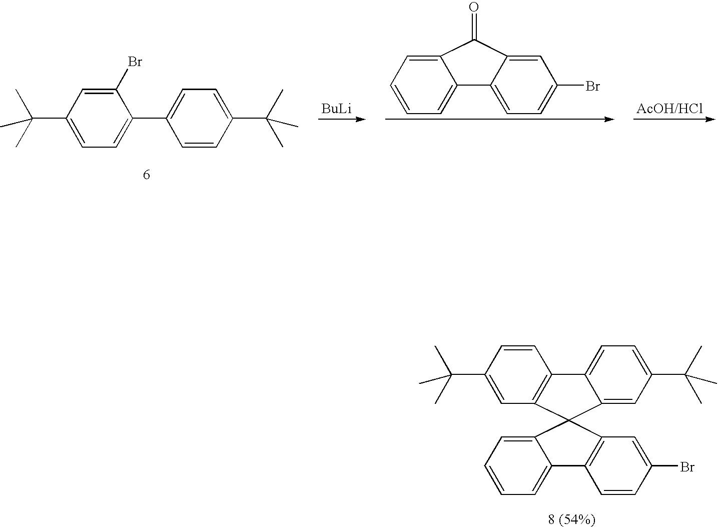

To a solution of the crude product of 2-bromo-4,4′-di-tert-butylbiphenyl (3.06 g, 5 mmol) in anhydrous THF (50 ml) was added dropwise n-BuLi (6 ml, 7.5 mmol) in hexane at −78° C., stirred 1 h, then the mixture was transferred to a solution of 2-bromofluorenone (1.3 g, 5 mmol) in THF (20 ml) at −78° C. and stirred overnight. Then the reaction was quenched with water and extracted with ethyl acetate (50 ml) 3 times. The organic layer was combined and washed with brine and dried over anhydrous MgSO₄ and concentrated in vacuo. The mixture was dissolved in glacial acetic acid (15 ml) and refluxed, and then one drop of concentrated HCl was added, refluxed 1 h. After the reaction was cooled to room temperature, the precipitate was filtrated and washed with water. The mixture of 2-bromo-(2′,7′-di-tert-butyl)-9,9′-spiro-bifluorene and 4,4′-di-tert-butylbiphenyl was separated by column chromatography (eluted with hexane) to provide solid product 1.37 g (54%). ¹H NMR (400 MHz, chloroform-d): δ, ppm 7.84 (d, 1H), 7.742 (d, 3H), 7.5 (d, 1H), 7.42 (m, 4H), 7.14 (t, 1H), 6.87 (s, 1H), 6.75 (d, 1H), 6.65 (s, 2H), 1.18 (s, 18H).

### Example 27

### Synthesis of 2-(4′-bromophenyl)pyridine (9)

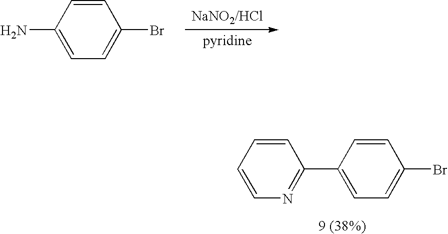

To a solution of 4-bromoaniline (2 g, 12 mmol) in concentrated HCl (4 ml) was added slowly the solution of NaNO₂ (1.66 g, 24 mmol) in H₂O (3 ml) at 0° C. The mixture was stirred 1 h at 0° C. and was poured into pyridine (50 ml). The mixture was stirred at 40° C. for 4 h and then sodium carbonate (20 g) was added and the slurry was stirred overnight. After cooling to room temperature, the mixture was washed with water and extracted with ethyl acetate. The organic layer was combined and washed with brine and dried over anhydrous MgSO₄ and concentrated in vacuo. After column chromatography (silica gel, ethyl acetate:hexane=1:10) to give product 1.03 g (38%)

### Example 28

### Synthesis of Compound 10

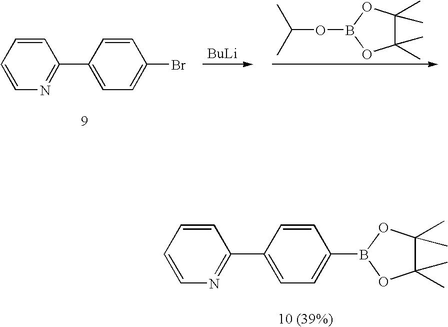

To a solution of 2-(4′-bromophenyl)pyridine (0.468 g, 2 mmol) in anhydrous THF (10 ml) was added dropwise n-BuLi (3 ml, 3.6 mmol) at −78° C. The reaction was stirred 1 h, then 2-isopropoxy-4,4,5,5-tetramethyl-1,3,2-dioxaborolane (0.52 ml, 2.5 mmol) was added. The mixture was stirred overnight. Then the reaction was quenched with water and extracted with dichloromethane (30 ml) 3 times. The organic layer was washed with brine and dried over MgSO₄ and concentrated in vacuo. After column chromatography (silica gel, ethyl acetate:hexane=1:20) to give product 0.22 g (39%).

### Example 29

### Synthesis of G

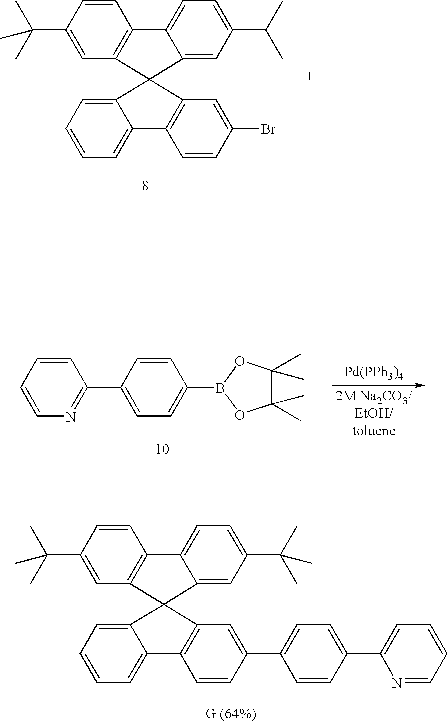

A mixture of 2-bromo-(2′,7′-di-tert-butyl)-9,9′-spiro-bifluorene (0.35 g, 0.7 mmol), compound 10 (0.22 g, 0.78 mmol), tetrakis(triphenylphosphine)palladium(0) (0.036 g, 0.03 mmol), aqueous sodium carbonate (2 M, 0.5 ml), ethanol (0.5 ml), toluene (4 ml) was deoxygenated and then heated to reflux under nitrogen, stirring overnight. After cooling to room temperature, the mixture was washed with water and extracted with ethyl acetate (20 ml) 3 times. The organic layer was then washed with brine and dried over MgSO₄ and concentrated in vacuo. After column chromatography (silica gel, ethyl acetate:hexane=1:5) to give G 0.26 g (64%). ¹H NMR (400 MHz, chloroform-d): δ, ppm 8.7 (s, 1H), 7.966 (t, 3H), 7.92 (d, 1H), 7.762 (m, 5H), 7.59 (d, 2H), 7.42 (d, 3H), 7.278 (d, 1H), 7.13 (t, 1H), 7.044 (s, 1H), 6.724 (d, 3H), 1.17 (s, 18H).

### Example 30

### Synthesis of G₂IrCl₂IrG₂

A mixture of G (0.813 g, 1.4 mmol), IrCl₃.nH₂O (0.247 g, 0.7 mmol), water (7.5 ml), 2-ethoxylethonal (22.5 ml) was deoxygenated and then heated to reflux under nitrogen for 24 h. After cooling to room temperature, the mixture was filtrated and washed with methanol to give 0.71 g of product (73%).

### Example 31

### Synthesis of G₂Ir(acac)

A mixture of chloride dimer (0.100 g, 0.036 mmol), 2,4-pentanedione (50 mg, 0.5 mmol), ethanol (0.1 ml), dichloromethane (3 ml) and 25% of tetramethylammonium hydroxide in methanol (0.05 ml) was deoxygenated and then heated to reflux under nitrogen for 2 h. After cooling to room temperature, the mixture was evaporated in vacuo. After the solvent was removed on a rotary evaporator, the residue was purified by recrystallization in heptane to provide 73 mg of G₂Ir(acac) (yield 70%).

### Example 32

### Preparation of Electroluminescent Device from A₂Ir(acac)

A first layer of poly(3,4-ethylenedioxythiophene) doped with poly(styrenesulfonic acid) (PEDOT:PSS) was spin-coated on a glass substrate with patterned ITO to form a hole injection layer with a thickness of about 50 nm. After dried in an oven at 120° C. for 5 min, solution containing 4 ml toluene, 40 mg PVK, 15 mg PBD, and 3.3 mg A₂Ir(acac) was spin-coated onto the first layer to form an emitting layer with a thickness of about 70 nm. On the polymer layer, 12 nm of BCP, 20 nm of Alq₃, 150 nm of Mg:Ag, and 10 nm of Ag were thermally deposited sequentially under vacuum of 3×10⁻⁴ Pa. The organic electroluminescent device obtained was examined in air. The brightness can reach 5701 cd/m² at 20 V and the maximum current efficiency is 4.3 cd/A.

### Example 33

### Preparation of Electroluminescent Device from B₂Ir(acac)

A first layer of poly(3,4-ethylenedioxythiophene) doped with poly(styrenesulfonic acid) (PEDOT:PSS) was spin-coated on a glass substrate with patterned ITO to form a hole injection layer with a thickness of about 50 nm. After dried in an oven at 120° C. for 5 min, solution containing 4 ml toluene, 40 mg PVK, 15 mg PBD, and 3.3 mg B₂Ir(acac) was spin-coated onto the first layer to form an emitting layer with a thickness of about 70 nm. On the polymer layer, 12 nm of BCP, 20 nm of Alq₃, 150 nm of Mg:Ag, and 10 nm of Ag were thermally deposited sequentially under vacuum of 3×10⁻⁴ Pa. The organic electroluminescent device obtained was examined in air. The brightness can reach 50866 cd/m² at 20 V and the maximum current efficiency is 34 cd/A.

### Example 34

### Preparation of Electroluminescent Device from C₂Ir(acac)

A first layer of poly(3,4-ethylenedioxythiophene) doped with poly(styrenesulfonic acid) (PEDOT:PSS) was spin-coated on a glass substrate with patterned ITO to form a hole injection layer with a thickness of about 50 nm. After dried in an oven at 120° C. for 5 min, solution containing 4 ml toluene, 40 mg PVK, 15 mg PBD, and 3.3 mg C₂Ir(acac) was spin-coated onto the first layer to form an emitting layer with a thickness of about 70 nm. On the polymer layer, 12 nm of BCP, 20 nm of Alq₃, 150 nm of Mg:Ag, and 10 nm of Ag were thermally deposited sequentially under vacuum of 3×10⁻⁴ Pa. The organic electroluminescent device obtained was examined in air. The brightness can reach 30543 cd/m² at 20 V and the maximum current efficiency is 31 cd/A.

### Example 35

### Preparation of Electroluminescent Device from D₂Ir(acac)

A first layer of poly(3,4-ethylenedioxythiophene) doped with poly(styrenesulfonic acid) (PEDOT:PSS) was spin-coated on a glass substrate with patterned ITO to form a hole injection layer with a thickness of about 50 nm. After dried in an oven at 120° C. for 5 min, solution containing 4 ml toluene, 40 mg PVK, 15 mg PBD, and 3.3 mg D₂Ir(acac) was spin-coated onto the first layer to form an emitting layer with a thickness of about 70 nm. On the polymer layer, 12 nm of BCP, 20 nm of Alq₃, 150 nm of Mg:Ag, and 10 nm of Ag were thermally deposited sequentially under vacuum of 3×10⁻⁴ Pa. The organic electroluminescent device obtained was examined in air. The brightness can reach 3177 cd/m² at 20 V and the maximum current efficiency is 2.7 cd/A.

### Example 36

### Preparation of Electroluminescent Device from E₂Ir(acac)

A first layer of poly(3,4-ethylenedioxythiophene) doped with poly(styrenesulfonic acid) (PEDOT:PSS) was spin-coated on a glass substrate with patterned ITO to form a hole injection layer with a thickness of about 50 nm. After dried in an oven at 120° C. for 5 min, solution containing 4 ml toluene, 40 mg PVK, 15 mg PBD, and 3.3 mg E₂Ir(acac) was spin-coated onto the first layer to form an emitting layer with a thickness of about 70 nm. On the polymer layer, 12 nm of BCP, 20 nm of Alq₃, 150 nm of Mg:Ag, and 10 nm of Ag were thermally deposited sequentially under vacuum of 3×10⁻⁴ Pa. The organic electroluminescent device obtained was examined in air. The brightness can reach 6177 cd/m² at 20 V and the maximum current efficiency is 5.1 cd/A.

### Example 37

### Preparation of Electroluminescent Device from F₂Ir(acac)

A first layer of poly(3,4-ethylenedioxythiophene) doped with poly(styrenesulfonic acid) (PEDOT:PSS) was spin-coated on a glass substrate with patterned ITO to form a hole injection layer with a thickness of about 50 nm. After dried in an oven at 120° C. for 5 min, solution containing 4 ml toluene, 40 mg PVK, 15 mg PBD, and 3.3 mg F₂Ir(acac) was spin-coated onto the first layer to form an emitting layer with a thickness of about 70 nm. On the polymer layer, 12 nm of BCP, 20 nm of Alq₃, 150 nm of Mg:Ag, and 10 mm of Ag were thermally deposited sequentially under vacuum of 3×10⁻⁴ Pa. The organic electroluminescent device obtained was examined in air. The brightness can reach 5697 cd/m² at 19.5 V and the maximum current efficiency is 4.8 cd/A.

### Example 38

### Preparation of Electroluminescent Device from G₂Ir(acac)

A first layer of poly(3,4-ethylenedioxythiophene) doped with poly(styrenesulfonic acid) (PEDOT:PSS) was spin-coated on a glass substrate with patterned ITO to form a hole injection layer with a thickness of about 50 nm. After dried in an oven at 120° C. for 5 min, solution containing 4 ml toluene, 40 mg PVK, 15 mg PBD, and 3.3 mg G₂Ir(acac) was spin-coated onto the first layer to form an emitting layer with a thickness of about 70 nm. On the polymer layer, 12 nm of BCP, 20 nm of Alq₃, 150 nm of Mg:Ag, and 10 nm of Ag were thermally deposited sequentially under vacuum of 3×10⁻⁴ Pa. The organic electroluminescent device obtained was examined in air. The brightness can reach 20620 cd/m² at 20 V and the maximum current efficiency is 12 cd/A.

1-35. (canceled)

36. An organometallic compound of formula (I): 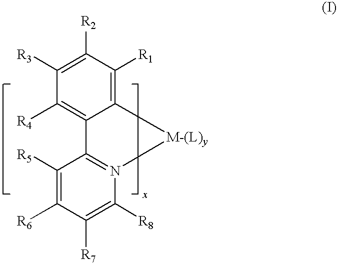
wherein:
M is a d-block metal having a coordination number z, wherein z=6 or 4;
R₁ and R₃ to R₈ are independently H, halo, optionally substituted alkyl, optionally substituted alkenyl, optionally substituted alkynyl, optionally substituted heteroalkyl, optionally substituted heteroalkenyl, optionally substituted heteroalkynyl, optionally substituted aryl, optionally substituted heteroaryl, amino, amido, carboxy, formyl, sulfo, sulfino, thioamido, hydroxy, halo, or cyano, and two or more of R₁ to R₈ may form a ring together with the carbon atoms to which they are attached,
R₂ is independently H, optionally substituted alkyl, optionally substituted alkenyl, optionally substituted alkynyl, optionally substituted heteroalkyl, optionally substituted heteroalkenyl, optionally substituted heteroalkynyl, optionally substituted aryl, optionally substituted heteroaryl, amino, amido, carboxy, formyl, sulfo, sulfino, thioamido, hydroxy, or cyano, and two or more of R₁ to R₈ may form a ring together with the carbon atoms to which they are attached,
if any one of R₁ to R₄ is H, none of R₅ to R₈ is H,
or if any one of R₅ to R₈ is H, none of R₁ to R₄ is H, or
at least one of R₁ to R₈ comprises a spiro group;
x is 1 to z/2;
L is a neutral or anionic ligand; and
y is (z−2x)/2.

37. The organometallic compound of claim 36 wherein none of R₁ to R₈ comprises a spiro group.

38. The organometallic compound of claim 37 wherein any one of R₁ to R₄ is H and none of R₅ to R₈ is H.

39. The organometallic compound of claim 38 wherein each of R₅ to R₈ is a substituted or unsubstituted aryl group or a substituted or unsubstituted heteroaryl group.

40. The organometallic compound of claim 37 wherein any one of R₅ to R₈ is H and none of R₁ to R₄ is H.

41. The organometallic compound of claim 40 wherein each of R₁ to R₄ is a substituted or unsubstituted aryl group or a substituted or unsubstituted heteroaryl group.

42. The organometallic compound of claim 37 wherein none of R₁ to R₄ is hydrogen.

43. The organometallic compound of claim 37 wherein at least one of R₁ and R₂, R₂ and R₃, R₃ and R₄, R₄ and R₅, R₅ and R₆, R₆ and R₇, R₇ and R₈ form a ring.

44. The organometallic compound of claim 36 wherein at least one of R₁ to R₈ comprises a spiro group.

45. The organometallic compound of claim 44 wherein at least one of R₁ to R₈ comprises a spirobifluorenyl group.

46. The organometallic complex of claim 36 wherein M is Ir, Pt, Re, Rh, Os, Au or Zn.

47. The organometallic complex of claim 46 wherein M is iridium.

48. The organometallic complex of claim 35 wherein y=1.

49. The organometallic complex of claim 35 wherein L is acetylacetone.

50. A solution comprising the organometallic complex of claim 35.

51. A film comprising the organometallic complex of claim 35.

52. The film according to claim 51 further comprising a charge-carrying host material.

53. The film according to claim 52 wherein the charge-carrying host material is PVK or a PVK/PBD blend.

54. The film according to claim 52 wherein the weight ratio of the organometallic complex to the charge-carrying host material is about 0.5% to about 50%.

55. The film according to claim 51 wherein the film has a thickness of about 20 nm to about 200 nm.

56. The film according to claim 51 wherein the film is prepared by a solution processing technique.

57. The film according to claim 56 wherein the solution processing technique is spin coating.

58. An electroluminescent device having an emissive layer, the emissive layer comprising the organometallic complex according to claim 35.

59. The electroluminescent device according to claim 58 wherein the layer further comprises a charge-carrying host material.

60. The electroluminescent device according to claim 59 wherein the weight ratio of the organometallic complex to the host material is about 5%.

61. The electroluminescent device according to claim 58 wherein the host material is PVK or a PVK/PBD blend.

62. The electroluminescent device according to claim 58 wherein the emissive layer is deposited by a solution processing technique.

63. The electroluminescent device according to claim 62 wherein the solution processing technique is spin coating.

64. The electroluminescent device according to claim 58 further comprising a hole-injecting layer.

65. The electroluminescent device according to claim 64 wherein the hole injecting layer comprises PEDOT-PSS.

66. The electroluminescent device according to claim 58 further comprising an electron transporting layer.

67. The electroluminescent device according to claim 66 wherein the electron transporting layer comprises Alq₃.

68. The electroluminescent device according to claim 58 further comprising a hole blocking layer.

69. The electroluminescent device according to claim 68 wherein the hole blocking layer comprises BCP or TPBI.

70. The organometallic compound of claim 1 wherein the substituted 2-phenylpyridine group is 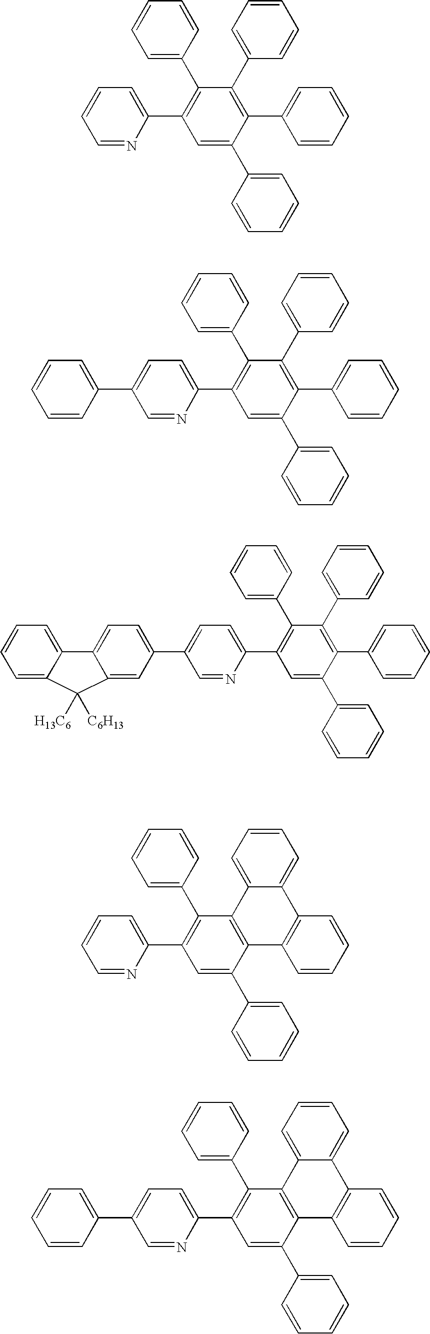 [chemical structure]
